(19) United States
(12) Patent Application Publication
(10) Pub. No.: US 2019/0125048 A1
(43) Pub. Date: May 2, 2019

(54) PROTECTIVE CASE FOR MOBILE DEVICE

(71) Applicant: Eli Altaras, Irvine, CA (US)

(72) Inventor: Eli Altaras, Irvine, CA (US)

(21) Appl. No.: 16/120,199

(22) Filed: Aug. 31, 2018

Related U.S. Application Data
(63) Continuation-in-part of application No. 15/795,578, filed on Oct. 27, 2017, now Pat. No. 10,091,899.

(51) Int. Cl. A45C 11/00; H01F 7/02; H04B 1/3888; A45C 13/10

(52) U.S. Cl. CPC A45C 11/00; H01F 7/02; H04M 1/0202; A45C 13/1069; H04B 1/3888

(57) ABSTRACT

The embodiments disclose an apparatus, including at least one digital device protective case, wherein a front magnet coupled case bumper with a plurality of magnets and a back magnet coupled case bumper with a plurality of magnets form a magnet coupled digital device protective case to hold and protect a digital device including a phone, wherein a back slide coupling and a front slide coupling slide into a slide coupled digital device protective case, a tempered glass front face and a tempered glass back for coupling to the front magnet coupled case bumper and back magnet coupled case bumper respectively, and wherein a slide coupled digital device protective case with one partially open end to insert and protect a digital device including a phone includes a front slide coupling coupled with the tempered glass front face and a back slide coupling coupled with the tempered glass back.

### CROSS-REFERENCE TO RELATED APPLICATIONS

This patent application is a Continuation-In-Part and claims priority to United States patent application entitled: “DIGITAL DEVICE PROTECTIVE CASE METHOD AND DEVICE”, U.S. Ser. No. 15/795,578 filed on Oct. 27, 2017, the U.S. patent application being incorporated herein by reference.

### BACKGROUND

When digital devices came onto the market they generally had functional design styling. Since that time consumers have shown a desire for more stylish devices along with expanded functionality. The current prevalence of digital devices includes a large variety of types including cell phones, smart phones, tablets, pods, laptops and others. The prices of these conveniences have dropped from the beginning to be more affordable to the general public. But, the prices are still an investment for most people. Unfortunately on occasions a user loses their grip on the digital device and it falls to a hard landing and is damaged. The cost of repair or replacement can be out of a user's immediate reach and at least causes the user great concern and at times trauma by being cut off from friends and family and even their work responsibilities. What is needed is a cost effective method to not only protect the digital device from damage but also allow the user to add styling to what might be a device that lacks their desired appeal and set it apart from the thousands of look-alike digital devices out in the public view.

### BRIEF DESCRIPTION OF THE DRAWINGS

FIG. 1 shows a block diagram of an overview of a digital device protective case method and devices of one embodiment.

FIG. 2 shows a block diagram of an overview of a digital device protective case method and devices of one embodiment.

FIG. 3 shows a block diagram of an overview flow chart of a digital device protective case method and devices of one embodiment.

FIG. 4 shows a block diagram of an overview flow chart of artwork designs processing of one embodiment.

FIG. 5 shows a block diagram of an overview flow chart of a third mold of one embodiment.

FIG. 6A shows for illustrative purposes only an example of digital device protective case flexible bumper of one embodiment.

FIG. 6B shows for illustrative purposes only an example of digital device protective case flexible bumper and back of one embodiment.

FIG. 6C shows for illustrative purposes only an example of digital device protective case flexible bumper and back rear view of one embodiment.

FIG. 6D shows for illustrative purposes only an example of digital device protective case flexible bumper and back front view of one embodiment.

FIG. 6E shows for illustrative purposes only an example of flexible bumper front tempered glass attachment ledge detail of one embodiment.

FIG. 7A shows for illustrative purposes only an example of a digital device protective case hard outer shell prospective view of one embodiment.

FIG. 7B shows for illustrative purposes only an example of a digital device protective case hard outer shell rear view of one embodiment.

FIG. 7C shows for illustrative purposes only an example of a digital device protective case hard outer shell front view of one embodiment.

FIG. 7D shows for illustrative purposes only an example of a tempered glass front face of one embodiment.

FIG. 8A shows for illustrative purposes only an example of a tempered glass front face in a perspective view of one embodiment.

FIG. 8B shows for illustrative purposes only an example of a digital device with the digital device protective case attached front view of one embodiment.

FIG. 8C shows for illustrative purposes only an example of a digital device with the digital device protective case attached prospective view of one embodiment.

FIG. 9A shows for illustrative purposes only an example of digital device protective case components and a digital device of one embodiment.

FIG. 9B shows for illustrative purposes only an example of digital device protective case components and a digital device assembled of one embodiment.

FIG. 9C shows for illustrative purposes only an example of a digital device protective case top perspective view of one embodiment.

FIG. 10A shows for illustrative purposes only an example of a hard shell flower pattern stock artwork design of one embodiment.

FIG. 10B shows for illustrative purposes only an example of a tempered glass front face with flower pattern stock artwork design of one embodiment.

FIG. 10C shows for illustrative purposes only an example of a downloadable image flower pattern stock artwork design of one embodiment.

FIG. 11A shows for illustrative purposes only an example of a hard shell ice cream cone pattern stock artwork design of one embodiment.

FIG. 11B shows for illustrative purposes only an example of a tempered glass front face with ice cream cone pattern stock artwork design of one embodiment.

FIG. 11C shows for illustrative purposes only an example of a downloadable image ice cream cone pattern stock artwork design of one embodiment.

FIG. 12A shows for illustrative purposes only an example of a tablet clear flexible rubber digital device protective case of one embodiment.

FIG. 12B shows for illustrative purposes only an example of a tablet clear flexible rubber digital device protective case back view of one embodiment.

FIG. 12C shows for illustrative purposes only an example of a tablet clear flexible rubber digital device protective case shows tablet color of one embodiment.

FIG. 13A shows for illustrative purposes only an example of a backlit ultrathin keyboard cover flat position of one embodiment.

FIG. 13B shows for illustrative purposes only an example of a backlit ultrathin keyboard cover tablet stand position of one embodiment.

FIG. 14 shows a block diagram of an overview of a personalized user artwork design of one embodiment.

FIG. 15 shows a block diagram of an overview of a converted user artwork design of one embodiment.

FIG. 16 shows a block diagram of an overview of a user selected stock artwork design and digital device protective case style of one embodiment.

FIG. 17 shows a block diagram of an overview of a user artwork design downloadable image of one embodiment.

FIG. 18A shows a block diagram of an overview of digital device protective case styles of several embodiments.

FIG. 18B shows a block diagram of an overview of additional digital device protective case styles of several embodiments.

FIG. 19 shows for illustrative purposes only an example of stock print case and stock glass selections of one embodiment.

FIG. 20 shows for illustrative purposes only an example of a stock art design power bank with blinking LED eyes of one embodiment.

FIG. 21A shows for illustrative purposes only an example of electronically stitched artwork designs of one embodiment.

FIG. 21B shows for illustrative purposes only an example of artwork design applications without electronic stitching of one embodiment.

FIG. 22 shows for illustrative purposes only an example of seamless artwork design applications with personalized middle section images of one embodiment.

FIG. 23 shows for illustrative purposes only an example of seamless artwork design applications with holographic images of one embodiment.

FIG. 24 shows for illustrative purposes only an example of a digital device protective case vending machine of one embodiment.

FIG. 25 shows for illustrative purposes only an example of magnet coupled digital device protective case of one embodiment.

FIG. 26A shows for illustrative purposes only an example of complimentary opposing magnet poles of one embodiment.

FIG. 26B shows for illustrative purposes only an example of complimentary opposing magnet guides of one embodiment.

FIG. 27 shows for illustrative purposes only an example of magnet coupled digital device protective case assembly of one embodiment.

FIG. 28A shows for illustrative purposes only an example of slide coupled digital device protective case of one embodiment.

FIG. 28B shows for illustrative purposes only an example of slide coupled digital device protective case with phone of one embodiment.

FIG. 29A shows for illustrative purposes only an example of a slide coupled digital device protective case cross section of one embodiment.

FIG. 29B shows for illustrative purposes only an example of a front slide coupling cross section of one embodiment.

FIG. 29C shows for illustrative purposes only an example of a back slide coupling cross section of one embodiment.

FIG. 30A shows for illustrative purposes only an example of a back slide coupling slid into position of one embodiment.

FIG. 30B shows for illustrative purposes only an example of a back slide coupling slid into position of one embodiment.

FIG. 30C shows for illustrative purposes only an example of a slide coupled digital device protective case open end of one embodiment.

FIG. 31 shows for illustrative purposes only an example of independently coupled digital device protective case bumpers of one embodiment.

FIG. 32A shows for illustrative purposes only an example of installing a tempered glass front cover on a cell phone of one embodiment.

FIG. 32B shows for illustrative purposes only an example of installing a tempered glass back cover on a cell phone of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the embodiments.

### General Overview:

It should be noted that the descriptions that follow, for example, in terms of digital device protective case method and device is described for illustrative purposes and the underlying system can apply to any number and multiple types of digital devices. In one embodiment of the present invention, the digital device protective case method and device includes using various specific digital device model customized shapes and sizes using the embodiments.

The term “seamless” and “seamlessly” as used herein refer to the results of the artwork design images applied to the digital device protective case physical components and the digital downloadable image component being processed and electronically “stitched” to the image on the case to the top, sides and bottom of the subject component. Electronic stitching of the artwork design to the adjoining corresponding image creates the visualization of an unbroken transition of the artwork design images and patterns from one component to another of one embodiment.

Electronic stitching is performed in a digital electronic stitching process. The digital stitching process includes stock artwork designs and user submitted artwork designs. Artwork designs are digitized and aligned along digital device protective case physical and digital component adjacent boundaries from one component to another. The digital stitching process is configured to factor into the process curvatures, prospective, image and pattern content continuations, area-based and edge-based alignments. The digital stitching process creates an appearance of an integral flow of continuous artwork design images and patterns without misalignments, disproportionate sizes, and inappropriate abrupt changes in image and pattern content of one embodiment.

The term “downloadable image”, “home screen”, “screen saver” are interchangeably used herein to refer to an artwork design digitally formatted for display usages on a digital device for example a home screen, a screen saver or other user desired usage. The artwork design digitally formatted is downloaded by a user onto their digital device.

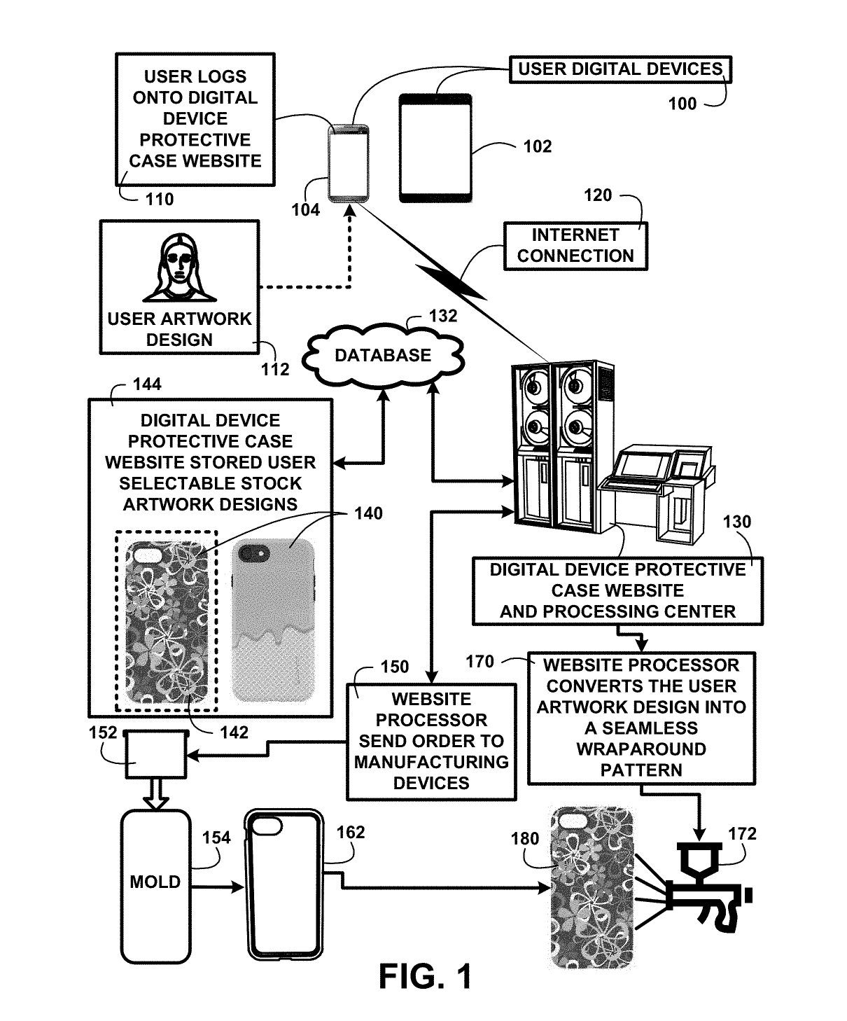

FIG. 1 shows a block diagram of an overview of a digital device protective case method and devices of one embodiment. FIG. 1 shows user digital devices 100 including a tablet 102 and cell phone 104 wherein a user logs onto a digital device protective case website 110. The user may load a user artwork design 112 onto user digital devices 100 for uploading via an internet connection 120 to the digital device protective case website 110.

A digital device protective case website and processing center 130 includes at least one database 132 for website stored user selectable stock artwork designs 144 for example stock artwork designs 140 and website stored user selectable digital device protective case styles. In this example a user selected stock artwork 142 is inputted into the processing center. Website processors send order to manufacturing devices 150 where case materials poured into mold 152. A mold 154 for various makes and models of user digital devices 100 are ready to match with the user designated digital device make and model.

A digital device protective case 162 is produced after the mold casting. The digital device protective case 162 is further processed in manufacture where user selected stock artwork is applied on the digital device protective case to complete order manufacture 172. The end product of the manufacturing is a digital device protective case with an applied stock artwork desgn 180. A user's order is then shipped to the user of one embodiment.

The digital device protective case is fashionable. In one embodiment a tempered glass feature on the front face of the digital device includes an electronically stitched artwork design that wraps the digital device completely with a seamless design. A front face includes a clear film. A film with an applied electronically stitched artwork design includes a front face insert including a printed film and a plastic front face insert. In one embodiment the digital device protective case includes a coordinating artwork design electronically stitched downloadable image for usages including a home screen and screen saver. In one embodiment an electronically stitched downloadable image seamlessly integrates with the front face of the digital device protective case. The electronically stitched artwork design seamlessly transitions on all of the sides of the digital device protective case making the appearance of a single and complete image that flows around the digital device protective case. The downloadable image is electronically stitched to the visible artwork design image of the case, including the sides, top; bottom the digital device protective case.

The electronically stitched downloadable image is provided to the user by any electronic means, including a barcode on the retail packaging, a URL link, via an email message, via a text message or other communication format. This unique bundle in one embodiment changes and transforms the digital device to include case features including a thermoplastic polyurethane (TPU) core, supported by a hard outer shell and tempered glass front face. The resulting digital device protective case is a high-end, extremely durable protection with a fashionable outlook.

### DETAILED DESCRIPTION

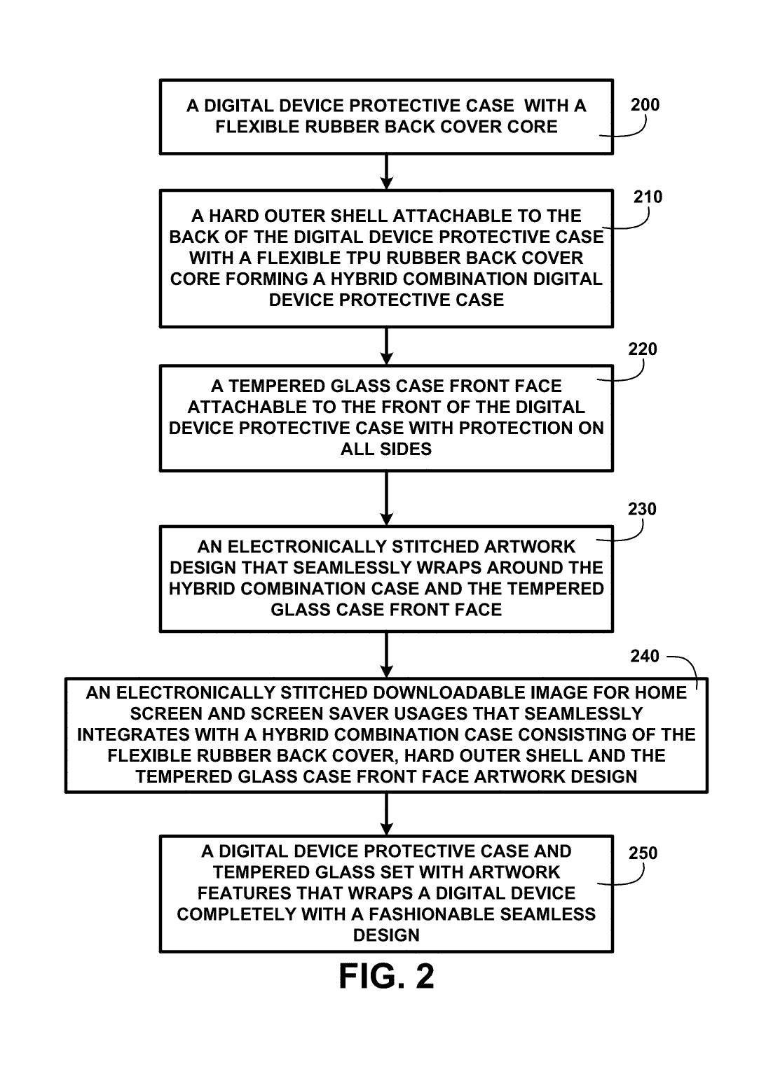

FIG. 2 shows a block diagram of an overview of digital device protective case method and devices of one embodiment. FIG. 2 shows a digital device protective case with a flexible rubber back cover core 200. A hard outer shell attachable to the back of the digital device protective case with a flexible TPU rubber back cover core forming a hybrid combination digital device protective case 210. A tempered glass case front face attachable to the front of the digital device protective case with protection on all sides 220.

An electronically stitched artwork design that seamlessly wraps around the hybrid combination case and the tempered glass case front face 230. An electronically stitched downloadable image for home screen and screen saver usages that seamlessly integrates with a hybrid combination case consisting of the flexible rubber back cover, hard outer shell and the tempered glass case front face artwork design 240. A digital device protective case and tempered glass set with artwork feature that wraps a digital device completely with a fashionable seamless design 250 of one embodiment.

### Digital Device Protective Case Method and Devices:

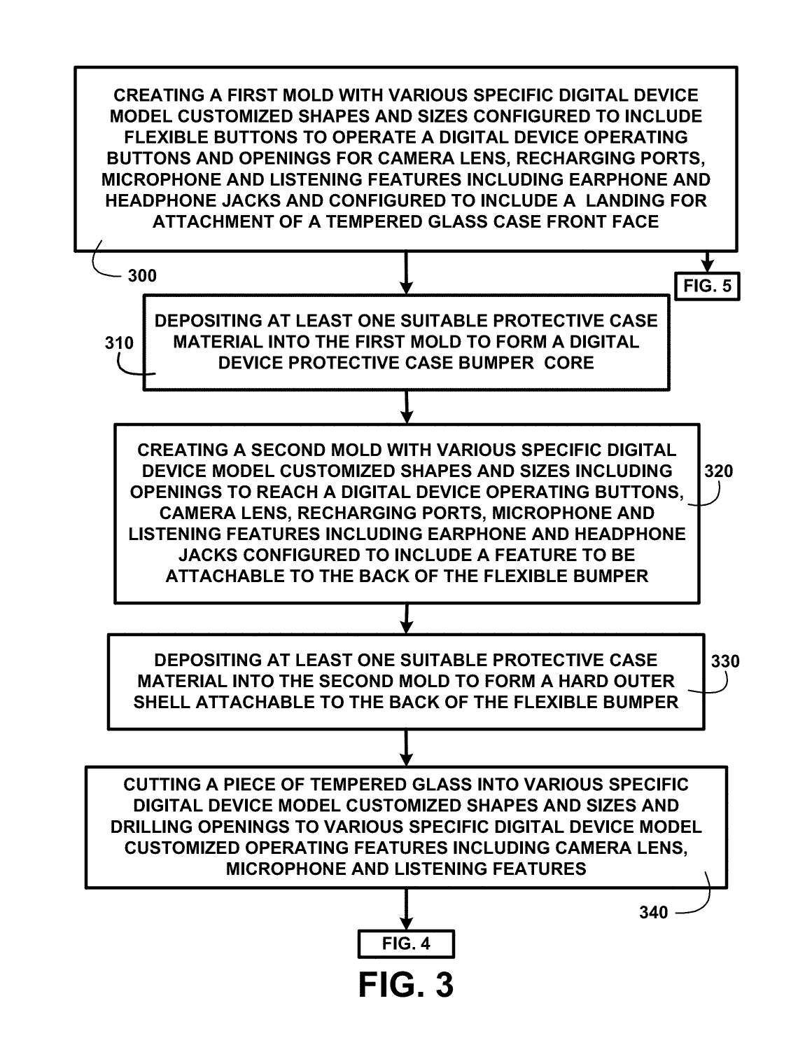

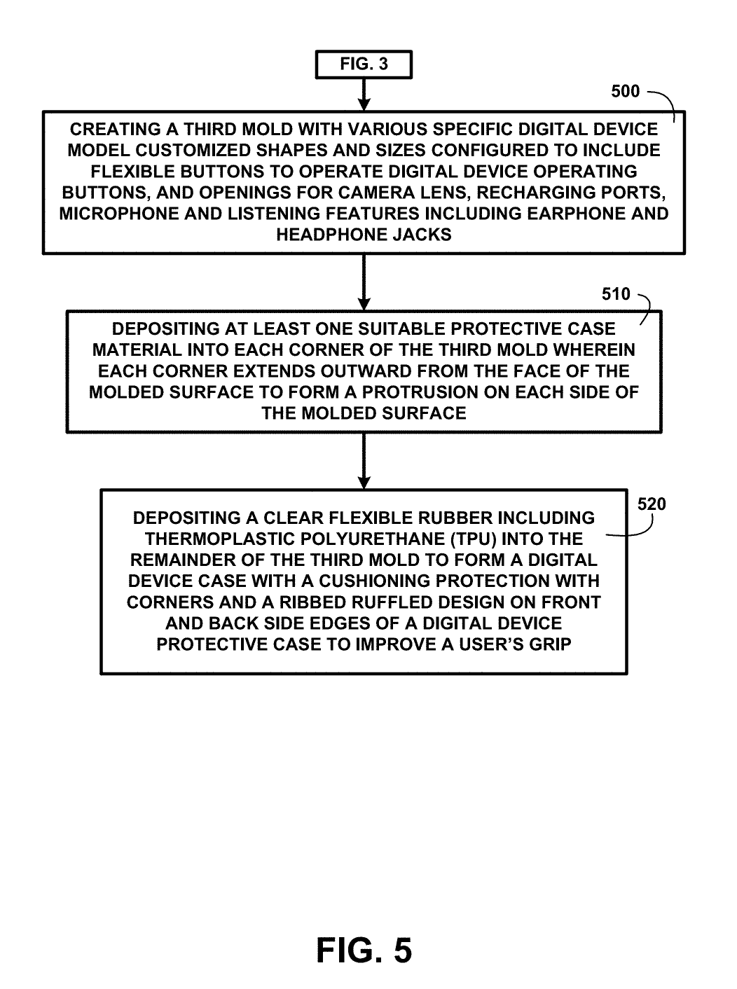

FIG. 3 shows a block diagram of an overview flow chart of a digital device protective case method and devices of one embodiment. FIG. 3 shows creating a first mold with various specific digital device model customized shapes and sizes includes flexible buttons to operate a digital device operating buttons and openings for camera lens, recharging ports, microphone and listening features including earphone and headphone jacks and includes a landing for attachment of a tempered glass case front face 300. The description continues on FIG. 5.

Depositing at least one suitable protective case material into the first mold to form a digital device protective case bumper core 310. At least one suitable protective case material includes a soft flexible plastic or rubberized material including a clear thermoplastic polyurethane (TPU), a hard setting plastic including a polycarbonate, a tempered glass, a metal including aluminum and titanium. Creating a second mold with various specific digital device model customized shapes and sizes including openings to reach a digital device operating buttons, camera lens, recharging ports, microphone and listening features including earphone and headphone jacks includes a feature to be attachable to the back of the flexible bumper 320. Depositing at least one suitable protective case material into the second mold to form a hard outer shell attachable to the back of a bumper 330. At least one suitable protective case material includes a soft flexible plastic or rubberized material including a clear thermoplastic polyurethane (TPU), a hard setting plastic including a polycarbonate, a tempered glass, a metal including aluminum and titanium of one embodiment.

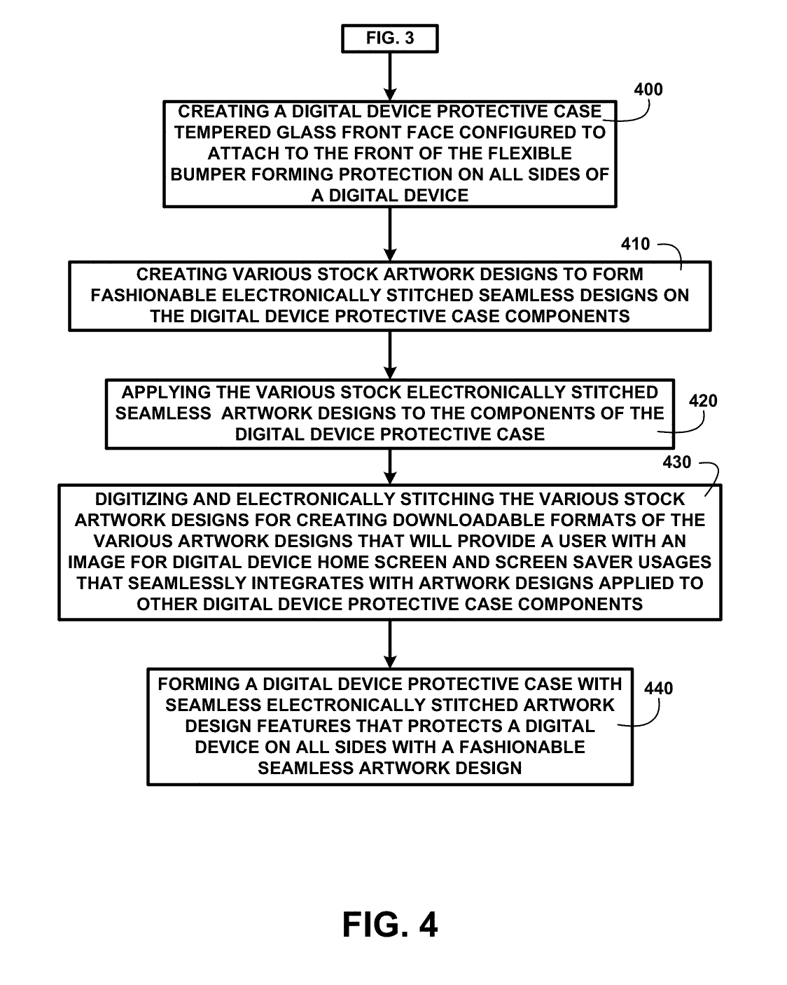

Cutting a piece of tempered glass into various specific digital device model customized shapes and sizes and drilling openings to various specific digital device model customized operating features including camera lens, microphone and listening features 340 of one embodiment. The description continues on FIG. 4.

### Artwork Designs Processing:

FIG. 4 shows a block diagram of an overview flow chart of artwork designs processing of one embodiment. FIG. 4 shows a continuation from FIG. 3 including creating a digital device protective case tempered glass front face to attach to the front of the flexible bumper forming protection on all sides of a digital device 400.

Creating various stock artwork designs to form fashionable electronically stitched seamless designs on the digital device protective case components 410 and applying the various stock electronically stitched seamless artwork designs to the components of the digital device protective case 420. Digitizing and electronically stitching the various stock artwork designs for creating downloadable formats including tablets and cell phones including PC, Mac, android, iPhone and other format compatibilities of the various artwork designs that will provide a user with an image for digital device home screen and screen saver usages that seamlessly integrates with artwork designs applied to other digital device protective case components 430. Forming a digital device protective case with seamless electronically stitched artwork design features that protects a digital device on all sides with a fashionable seamless artwork design 440 of one embodiment.

### Third Mold:

FIG. 5 shows a block diagram of an overview flow chart of a third mold of one embodiment. FIG. 5 shows a continuation from FIG. 3 with creating a third mold with various specific digital device model customized shapes and sizes includes flexible buttons to operate digital device operating buttons, and openings for camera lens, recharging ports, microphone and listening features including earphone and headphone jacks 500. Depositing at least one suitable protective case material into each corner of the third mold wherein each corner extends outward from the face of the molded surface to form a protrusion on each side of the molded surface 510. At least one suitable protective case material includes a soft flexible plastic or rubberized material including a clear thermoplastic polyurethane (TPU), a hard setting plastic including a polycarbonate, a tempered glass, a metal including aluminum and titanium. Depositing a clear flexible rubber including thermoplastic polyurethane (TPU) into the remainder of the third mold to form a digital device case with a cushioning protection with corners and a ribbed ruffled design on front and back side edges of a digital device protective case to improve a user's grip 520 of one embodiment.

### Digital Device Protective Case Flexible Bumper:

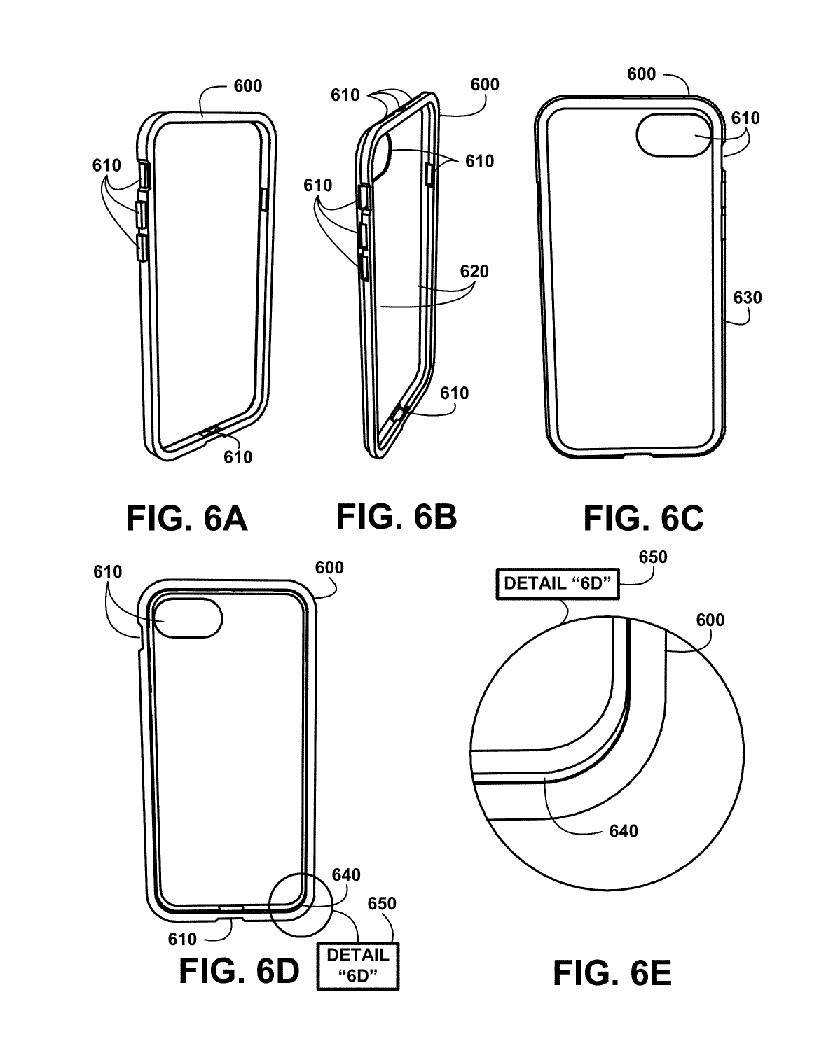

FIG. 6A shows for illustrative purposes only an example of digital device protective case flexible bumper of one embodiment. FIG. 6A shows a digital device protective case flexible bumper 600 that provide protection to the corners and edges of a digital device. Flexible buttons 610 allow a user to operate the buttons on the digital device with the digital device protective case flexible bumper placed on the device of one embodiment.

### Digital Device Protective Case Flexible Bumper and Back:

FIG. 6B shows for illustrative purposes only an example of digital device protective case flexible bumper and back of one embodiment. FIG. 6B shows the digital device protective case flexible bumper 600 with flexible buttons 610. A digital device protective case flexible bumper back 620 is attached to the digital device protective case flexible bumper 600. A large opening can be seen on the digital device protective case flexible bumper back 620 and can be for example for a digital device camera clear view towards the back of one embodiment.

### Digital Device Protective Case Flexible Bumper and Back Rear View:

FIG. 6C shows for illustrative purposes only an example of digital device protective case flexible bumper and back rear view of one embodiment. FIG. 6C shows the digital device protective case flexible bumper 600 including the flexible buttons 610. A digital device protective case flexible bumper back rear view 630 clearly shows the large opening that can be for example for a digital device camera clear view towards the back of one embodiment.

### Digital Device Protective Case Flexible Bumper and Back Front View:

FIG. 6D shows for illustrative purposes only an example of digital device protective case flexible bumper and back front view of one embodiment. FIG. 6D shows the digital device protective case flexible bumper 600 and flexible buttons 610. Also shown is a flexible bumper front tempered glass attachment ledge 640, shown in greater detail in FIG. 6E with an enlargement of detail “6D” 650 of one embodiment.

### Flexible Bumper Front Tempered Glass Attachment Ledge Detail:

FIG. 6E shows for illustrative purposes only an example of flexible bumper front tempered glass attachment ledge detail of one embodiment. FIG. 6E shows detail “6D” 650 showing a corner section of the digital device protective case flexible bumper 600 and the flexible bumper front tempered glass attachment ledge 640 of one embodiment.

### Digital Device Protective Case Hard Outer Shell Prospective View:

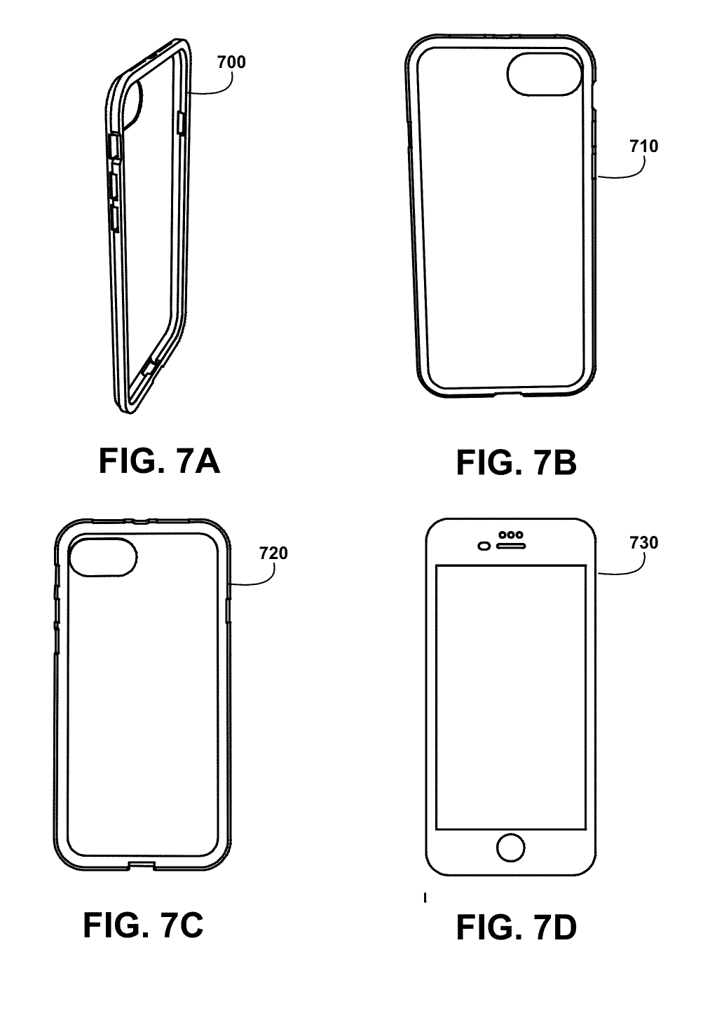

FIG. 7A shows for illustrative purposes only an example of a digital device protective case hard outer shell prospective view of one embodiment. FIG. 7A shows a digital device protective case hard outer shell 700 in perspective view and cutouts for flexible buttons 610 of FIG. 6A on the flexible bumper 600 of FIG. 6A. Also shown is the large opening to match the size and position of the large opening on the flexible back 620 of FIG. 6B of one embodiment.

### Digital Device Protective Case Hard Outer Shell Rear View:

FIG. 7B shows for illustrative purposes only an example of a digital device protective case hard outer shell rear view of one embodiment. FIG. 7B shows a digital device protective case hard outer shell rear view 710 and cutouts for flexible buttons 610 of FIG. 6A on the flexible bumper 600 of FIG. 6A. Also shown is the large opening to match the size and position of the large opening on the flexible back 620 of FIG. 6B of one embodiment.

### Digital Device Protective Case Hard Outer Shell Front View:

FIG. 7C shows for illustrative purposes only an example of a digital device protective case hard outer shell front view of one embodiment. FIG. 7C shows digital device protective case hard outer shell front view 720 and cutouts for flexible buttons 610 of FIG. 6A on the flexible bumper 600 of FIG. 6A. Also shown is the large opening to match the size and position of the large opening on the flexible back 620 of FIG. 6B of one embodiment.

### Tempered Glass Front Face:

FIG. 7D shows for illustrative purposes only an example of a tempered glass front face of one embodiment. FIG. 7D shows a tempered glass front face 730 and cutouts to access a digital device features including buttons, home button, speaker and microphone of one embodiment.

### Tempered Glass Front Face in a Perspective View:

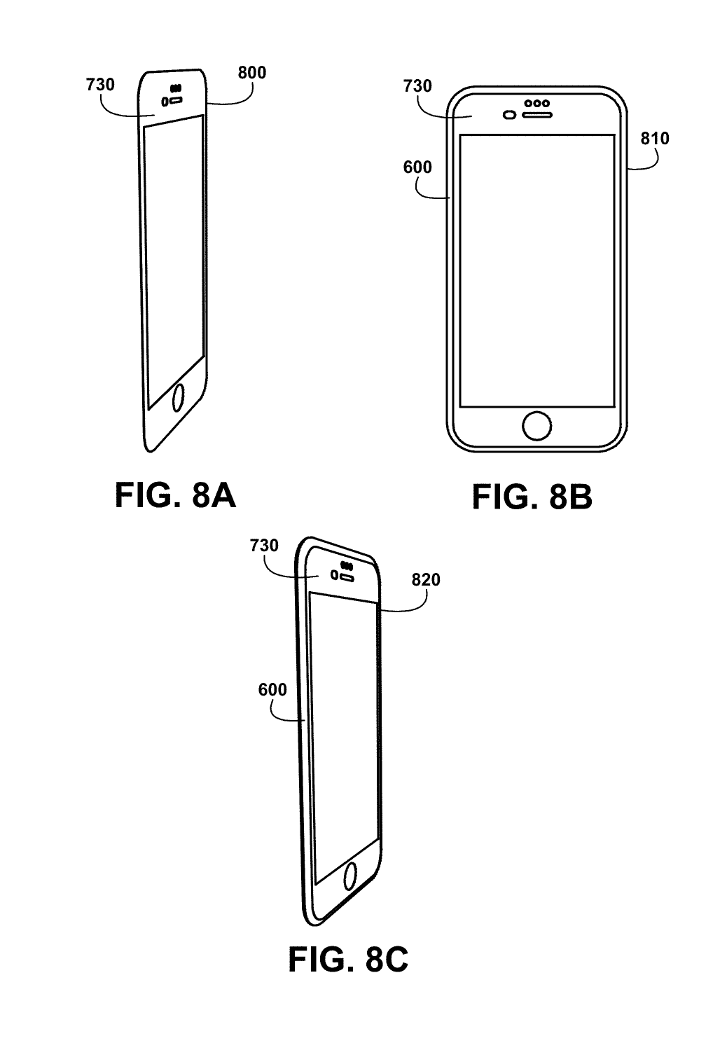

FIG. 8A shows for illustrative purposes only an example of a tempered glass front face in a perspective view of one embodiment. FIG. 8A shows a tempered glass front face 730 in a perspective view 800 showing the cutouts to access digital device features including buttons, home button, speaker and microphone of one embodiment.

A Digital Device with the Digital Device Protective Case Attached Front View:

FIG. 8B shows for illustrative purposes only an example of a digital device with the digital device protective case attached front view of one embodiment. FIG. 8B shows a digital device with the digital device protective case attached front view 810 showing the tempered glass front face 730 and the edges of the flexible bumper 600.

A Digital Device with the Digital Device Protective Case Attached Prospective View:

FIG. 8C shows for illustrative purposes only an example of a digital device with the digital device protective case attached prospective view of one embodiment. FIG. 8C shows a digital device with the digital device protective case attached prospective view 820 illustrating the slim fit of the digital device protective case with the tempered glass front face 730 and the flexible bumper 600 of one embodiment.

### Digital Device Protective Case Components and a Digital Device:

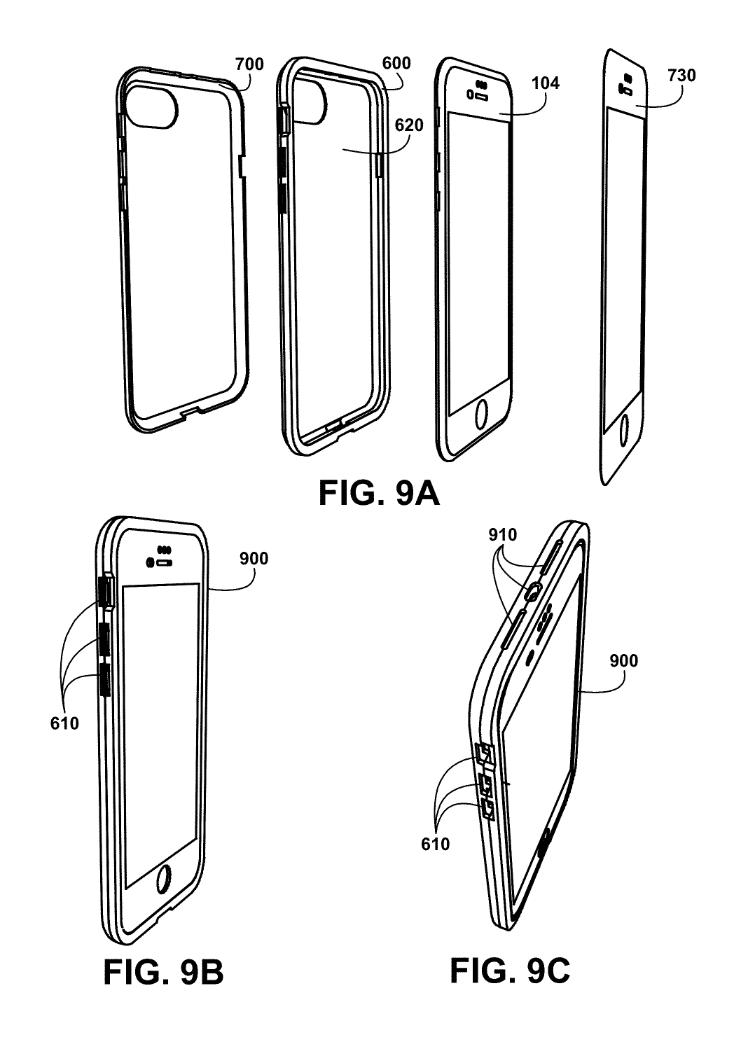

FIG. 9A shows for illustrative purposes only an example of a digital device protective case components and a digital device of one embodiment. FIG. 9A shows digital device protective case components including the digital device protective case hard outer shell 700, the flexible bumper 600 with the flexible back 620 cover core and the tempered glass front face 730. Also shown is an example of user digital devices 100 of FIG. 1, a cell phone 104 of one embodiment.

### Digital Device Protective Case Components and a Digital Device Assembled:

FIG. 9B shows for illustrative purposes only an example of a digital device protective case components and a digital device assembled of one embodiment. FIG. 9B shows a digital device protective case attached on all sides of a digital device 900 of one embodiment.

### Digital Device Protective Case Top Perspective View:

FIG. 9C shows for illustrative purposes only an example of a digital device protective case top perspective view of one embodiment. FIG. 9C shows a digital device protective case attached on all sides of a digital device 900 in a top perspective view. The flexible buttons 610 and cell phone top openings 910 are visible from this view of one embodiment.

### Hard Shell Flower Pattern Stock Artwork Design:

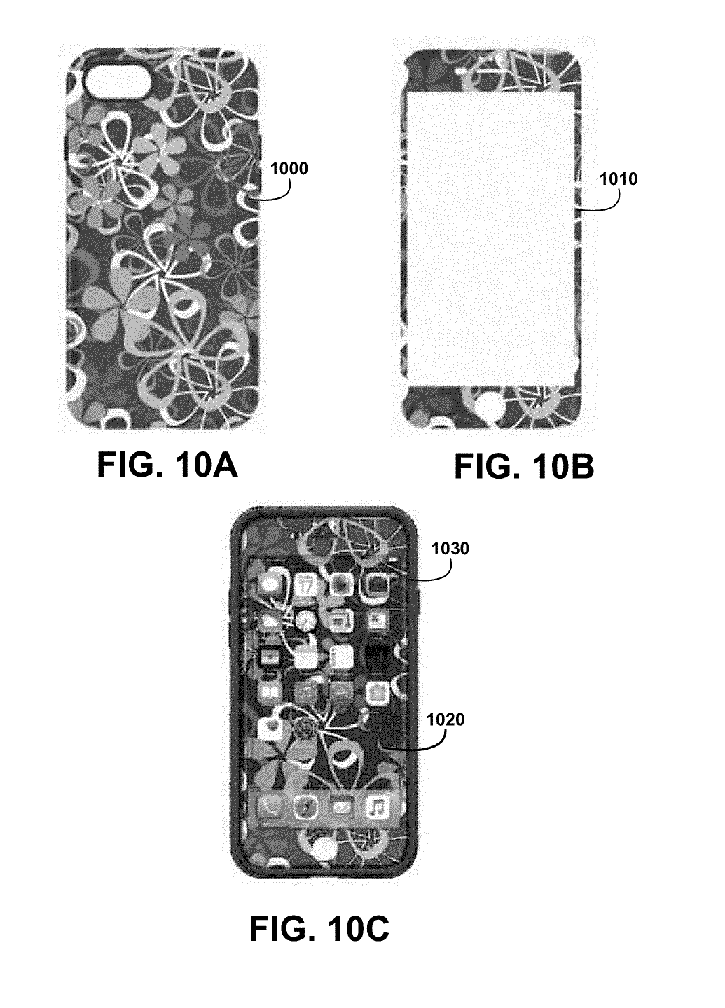

FIG. 10A shows for illustrative purposes only an example of a hard shell flower pattern stock artwork design of one embodiment. FIG. 10A shows a hard shell flower pattern stock artwork design 1000 of one embodiment.

Tempered Glass Front Face with Flower Pattern Stock Artwork Design:

FIG. 10B shows for illustrative purposes only an example of a tempered glass front face with flower pattern stock artwork design of one embodiment. FIG. 10B shows tempered glass front face with flower pattern stock artwork design 1010 of one embodiment.

### Downloadable Image Flower Pattern Stock Artwork Design:

FIG. 10C shows for illustrative purposes only an example of a downloadable image flower pattern stock artwork design of one embodiment. FIG. 10C shows downloadable image flower pattern stock artwork design 1020 and the digital device protective case bumper edges 1030 of one embodiment.

### Hard Shell Ice Cream Cone Pattern Stock Artwork Design:

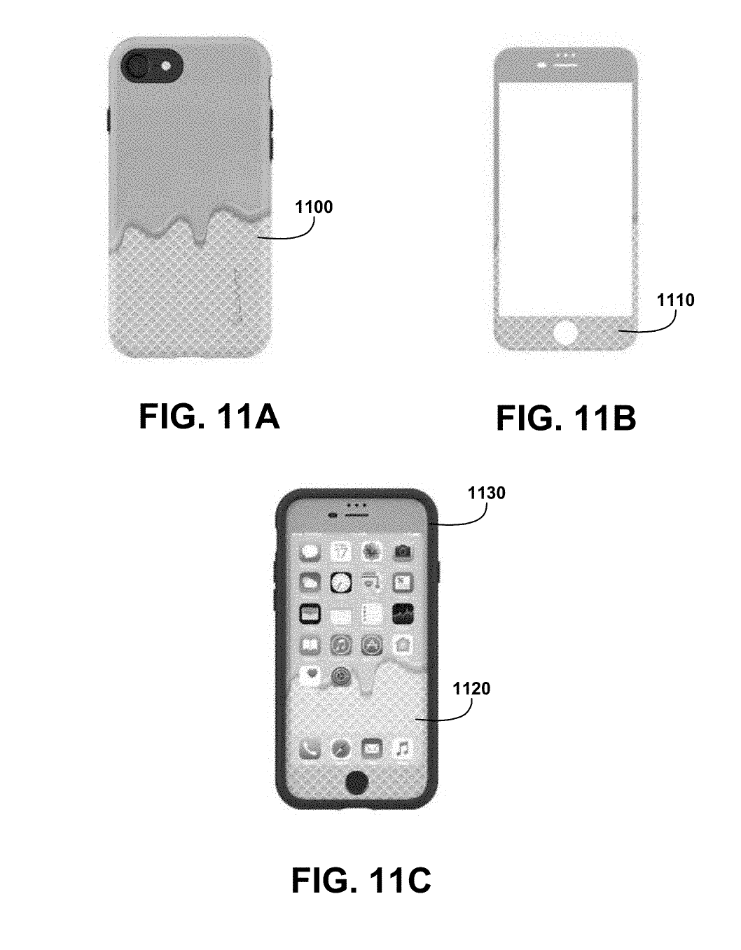

FIG. 11A shows for illustrative purposes only an example of a hard shell ice cream cone pattern stock artwork design of one embodiment. FIG. 11A shows a hard shell ice cream cone pattern stock artwork design 1100 of one embodiment.

Tempered Glass Front Face with Ice Cream Cone Pattern Stock Artwork Design:

FIG. 11B shows for illustrative purposes only an example of a tempered glass front face with ice cream cone pattern stock artwork design of one embodiment. FIG. 11B shows tempered glass front face with ice cream cone pattern stock artwork design 1110 of one embodiment.

### Downloadable Image Ice Cream Cone Pattern Stock Artwork Design:

FIG. 11C shows for illustrative purposes only an example of a downloadable image ice cream cone pattern stock artwork design of one embodiment. FIG. 11C shows a downloadable image ice cream cone pattern stock artwork design 1120 and bumper edges 1130 of one embodiment.

### Tablet Clear Flexible Rubber Digital Device Protective Case:

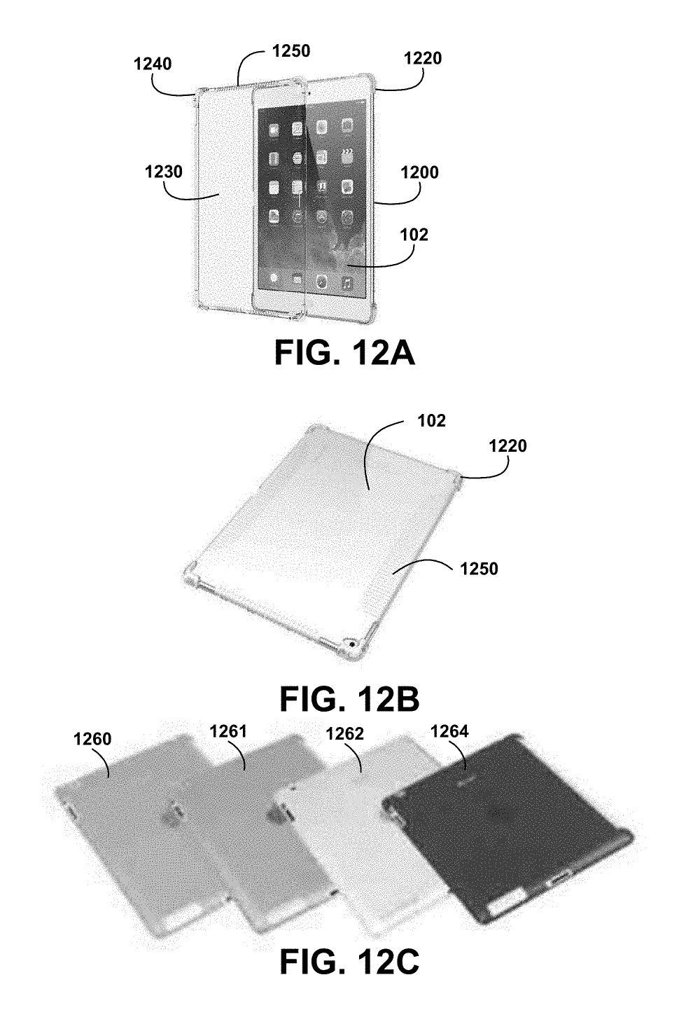

FIG. 12A shows for illustrative purposes only an example of a tablet clear flexible rubber digital device protective case of one embodiment. FIG. 12A shows a tablet clear flexible rubber digital device protective case front case 1230 being assembled on a user digital device 100 of FIG. 1 for example a tablet 102. Shown are the raised protruding front case bumper corners 1240 and ribbed ruffled design hand grip 1250. Also showing are raised protruding back case bumper corners 1220 and back case edge with ribbed ruffled design hand grip 1200 of one embodiment.

### Tablet Clear Flexible Rubber Digital Device Protective Case Back View:

FIG. 12B shows for illustrative purposes only an example of a tablet clear flexible rubber digital device protective case back view of one embodiment. FIG. 12B shows a tablet clear flexible rubber digital device protective case back view including the tablet 102, raised protruding back case bumper corners 1220, and ribbed ruffled design hand grip 1250 of one embodiment.

### Tablet Clear Flexible Rubber Digital Device Protective Case Shows Tablet Color:

FIG. 12C shows for illustrative purposes only an example of a tablet clear flexible rubber digital device protective case shows tablet color of one embodiment. FIG. 12C shows a tablet clear flexible rubber digital device protective case shows tablet color through the clear digital device protective case material. A clear flexible rubber digital device protective case shows pink tablet color 1260, a clear flexible rubber digital device protective case shows blue tablet color 1261, a clear flexible rubber digital device protective case shows silver tablet color 1262, and a clear flexible rubber digital device protective case shows charcoal tablet color 1264 of one embodiment.

### Backlit Ultrathin Keyboard Cover Flat Position:

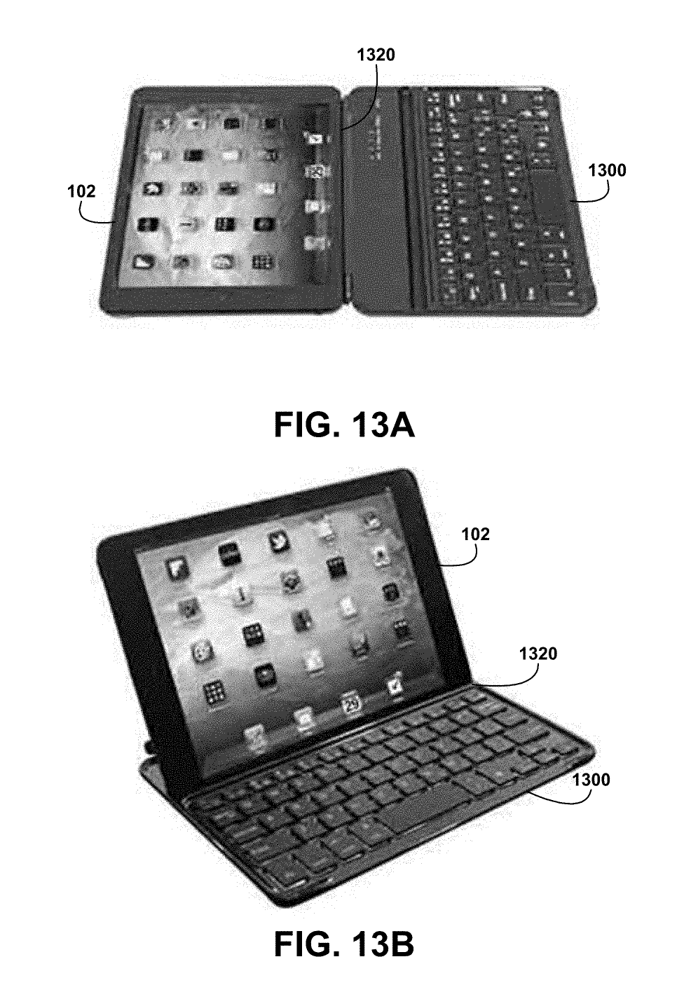

FIG. 13A shows for illustrative purposes only an example of a backlit ultrathin keyboard cover flat position of one embodiment. FIG. 13A shows a backlit ultrathin keyboard cover flat position coupled to the tablet 102. The backlit ultrathin keyboard cover 1300 is a digital device protective case that protects the screen of the tablet 102. The backlit ultrathin keyboard cover 1300 is coupled to the tablet 102 using a magnetic spine 1320 that latches to the side of the tablet 102 and is strong enough to support the full weight of the tablet, even as it swings in mid-air of one embodiment

### Backlit Ultrathin Keyboard Cover Tablet Stand Position:

FIG. 13B shows for illustrative purposes only an example of a backlit ultrathin keyboard cover tablet stand position of one embodiment. FIG. 13B shows a backlit ultrathin keyboard cover tablet stand position. The tablet 102 is coupled to the backlit ultrathin keyboard cover 1300 using a magnetic spine 1320. When the user wants to begin typing, the tablet 102 can rest, at a fixed angle, in either landscape or portrait mode in a slot above the keyboard of one embodiment.

### Personalized User Artwork Design:

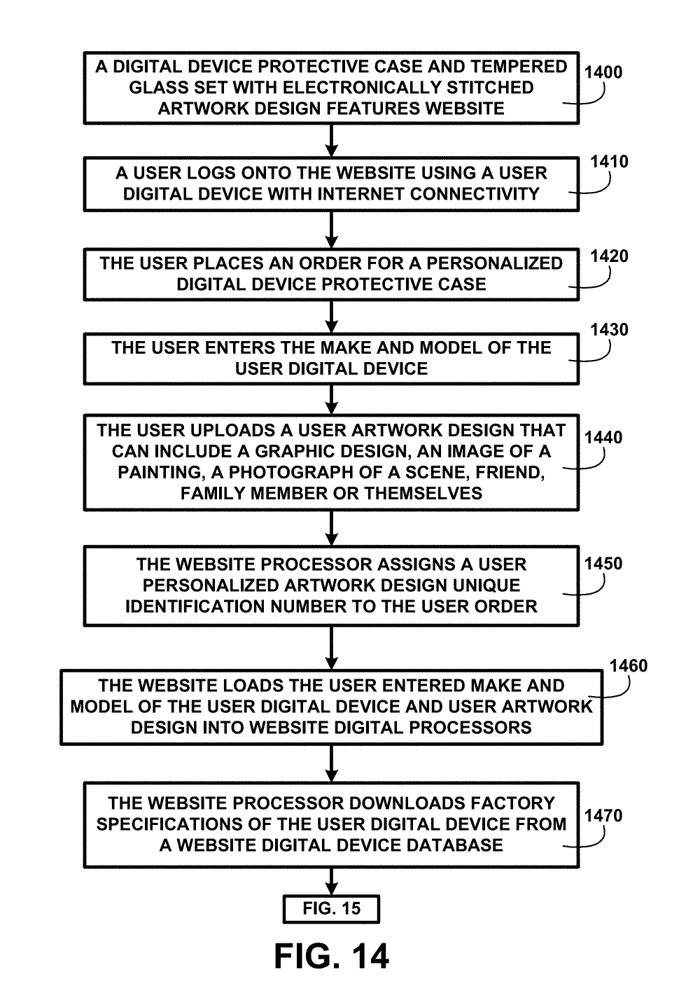

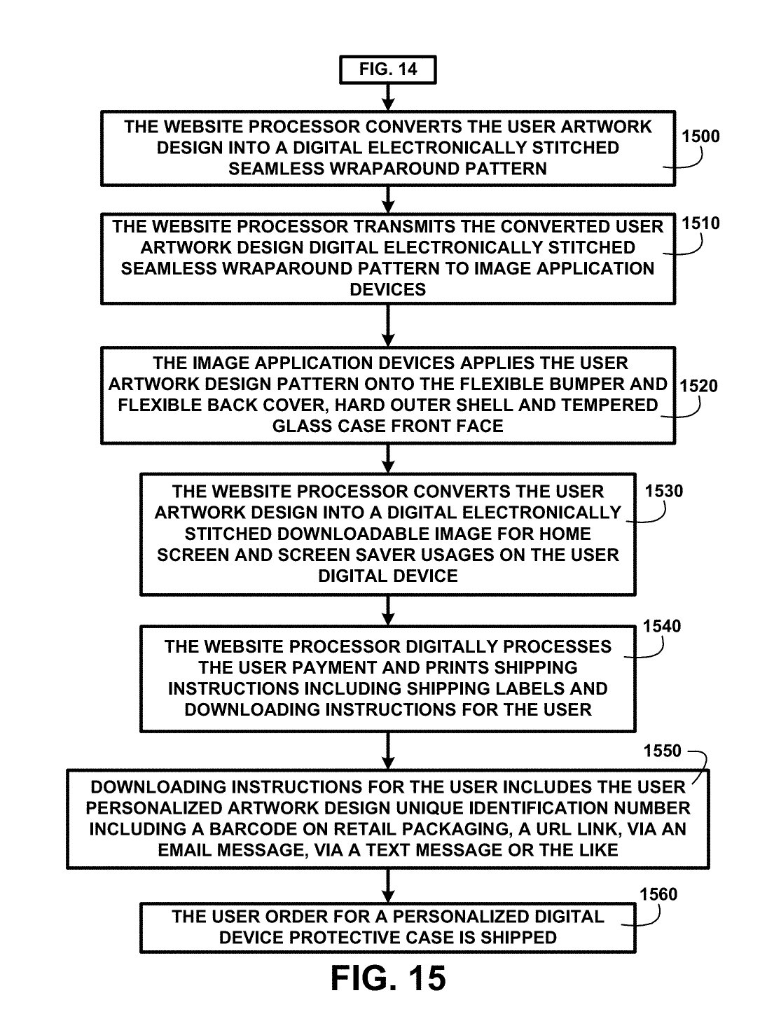

FIG. 14 shows a block diagram of an overview of a personalized user artwork design of one embodiment. FIG. 14 shows a digital device protective case and tempered glass set with electronically stitched artwork design features website 1400. A user logs onto the website using a user digital device with internet connectivity 1410. The user places an order for a personalized digital device protective case 1420. The user enters the make and model of the user digital device 1430. The user uploads a user artwork design that includes a graphic design, an image of a painting, and a photograph of a scene, friend, family member or themselves 1440. The website processor assigns a user personalized artwork design unique identification number to the user order 1450. The website loads the user entered make and model of the user digital device and user artwork design into website digital processors 1460. The website processor downloads factory specifications of the user digital device from a website digital device database 1470 of one embodiment. The description continues on FIG. 15.

### Converted User Artwork Design:

FIG. 15 shows a block diagram of an overview of a converted user artwork design of one embodiment. FIG. 15 shows a continuation from FIG. 14 where the website processor converts the user artwork design into a digital electronically stitched seamless wraparound pattern 1500. The website processor transmits the converted user artwork design digital electronically stitched seamless wraparound pattern to image application devices 1510. The image application devices applies the user artwork design pattern onto the flexible bumper and flexible back cover, hard outer shell and tempered glass case front face 1520. The website processor converts the user artwork design into a digital electronically stitched downloadable image for home screen and screen saver usages on the user digital device 1530. The website processor digitally processes the user payment and prints shipping instructions including shipping labels and downloading instructions for the user 1540. Downloading instructions for the user includes a user personalized artwork design unique identification number including a barcode on retail packaging, a URL link, via an email message, via a text message or the like 1550. The user order for a personalized digital device protective case is shipped 1560 of one embodiment.

### User Selected Stock Artwork Design and Digital Device Protective Case Style:

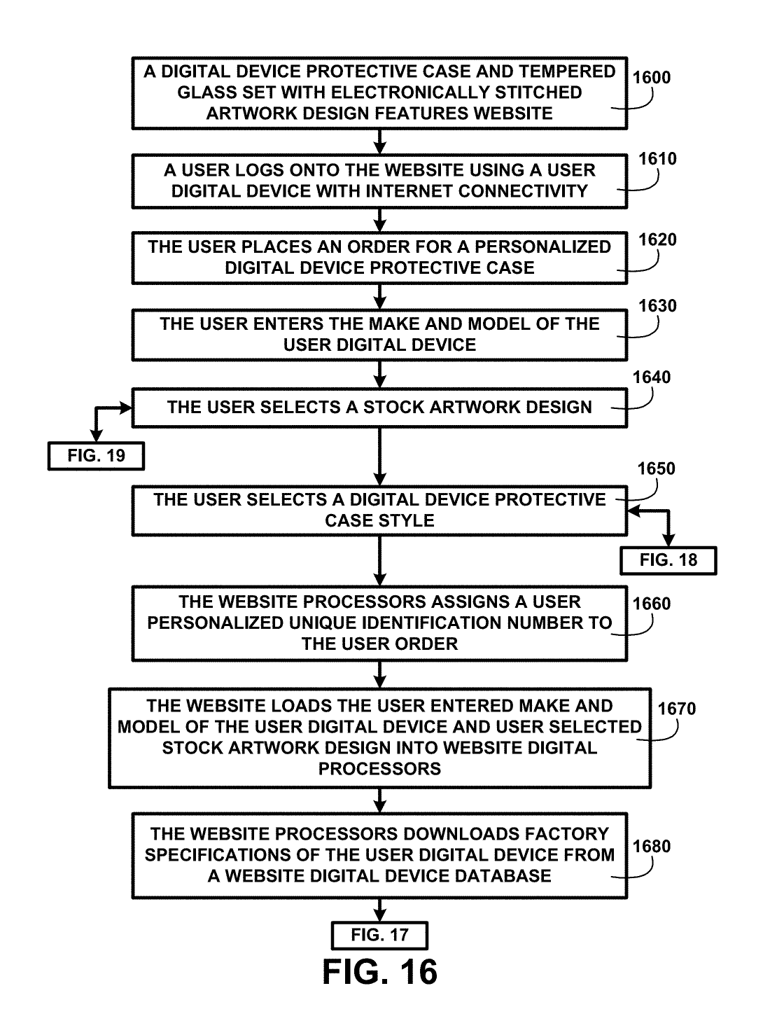

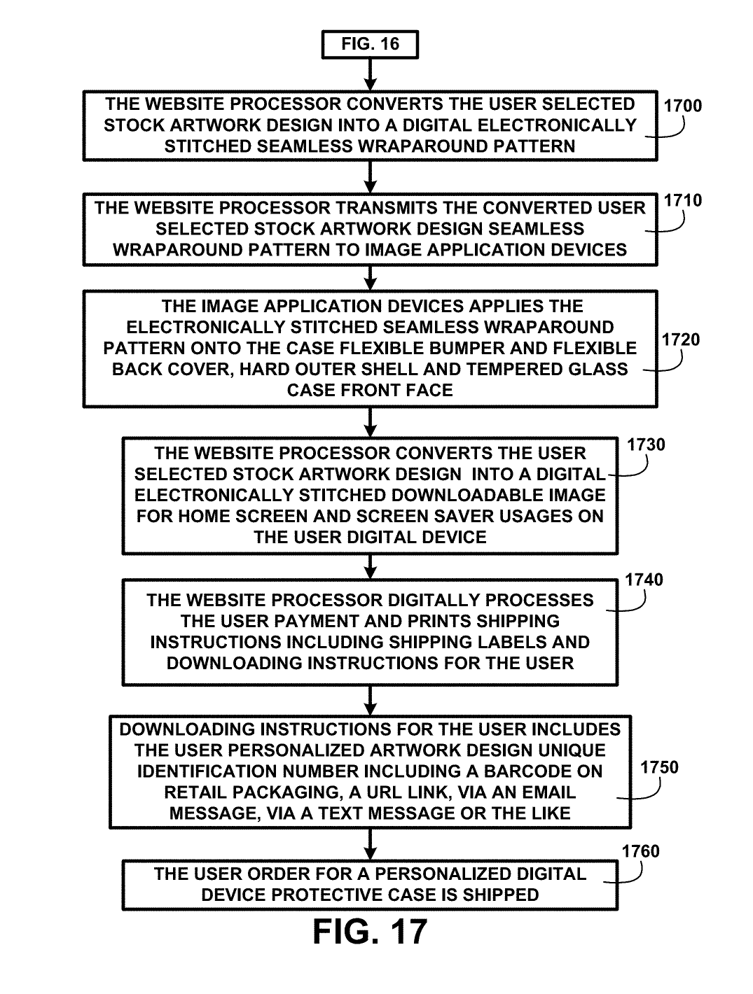

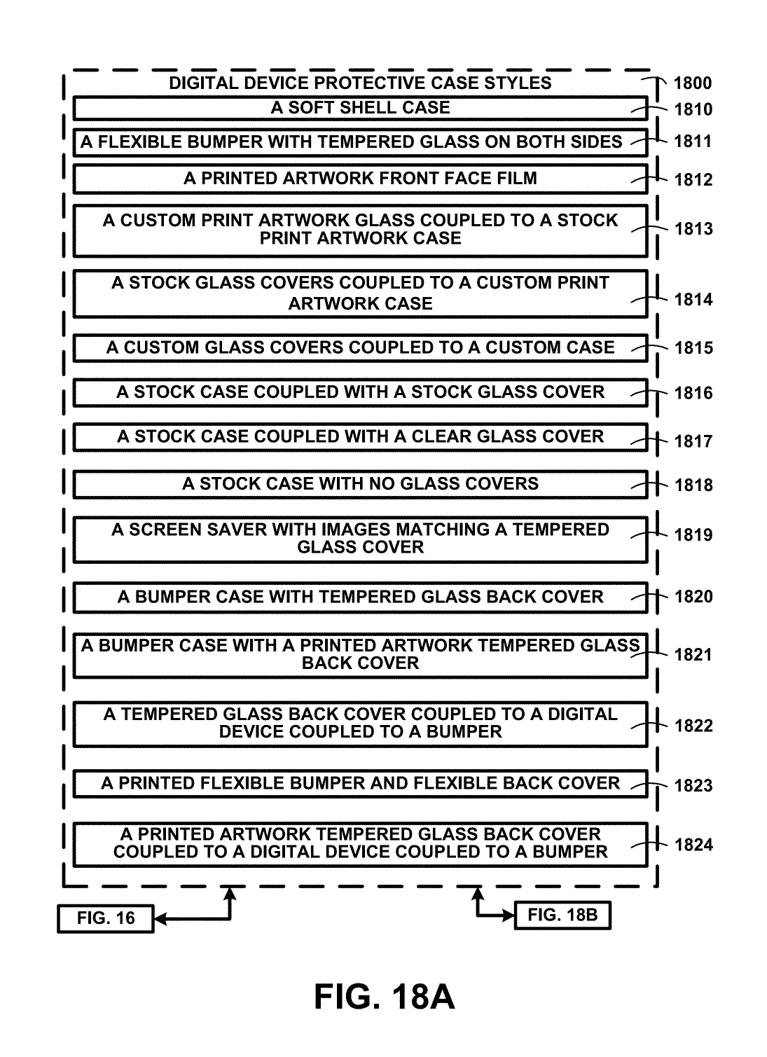

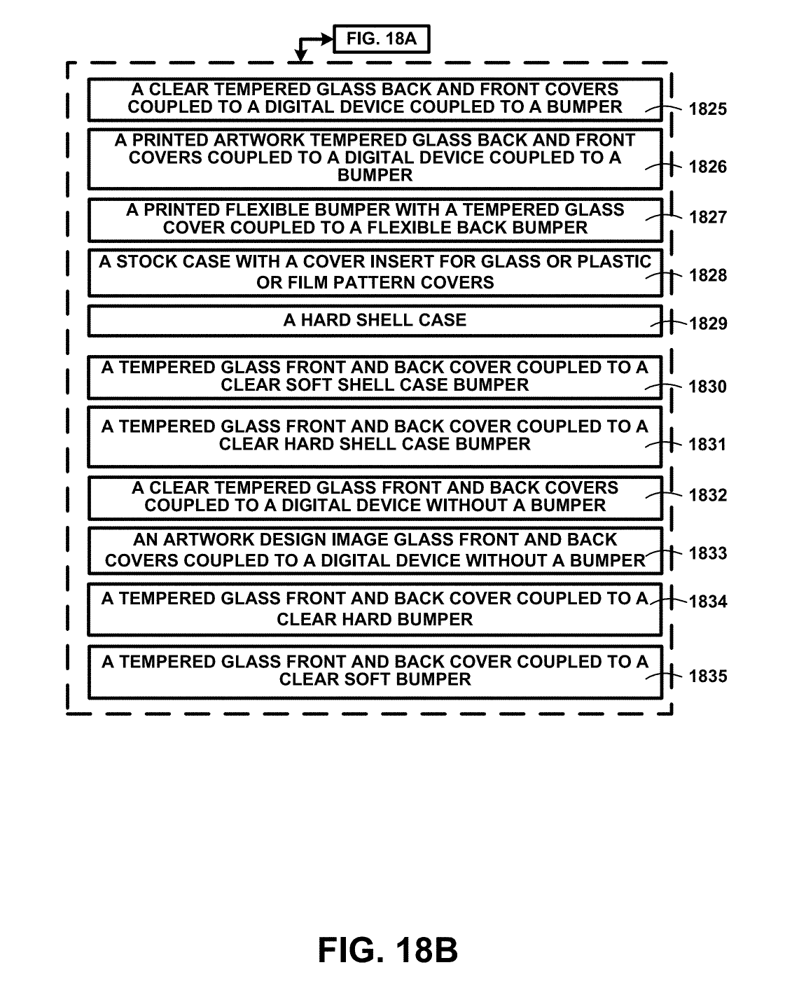

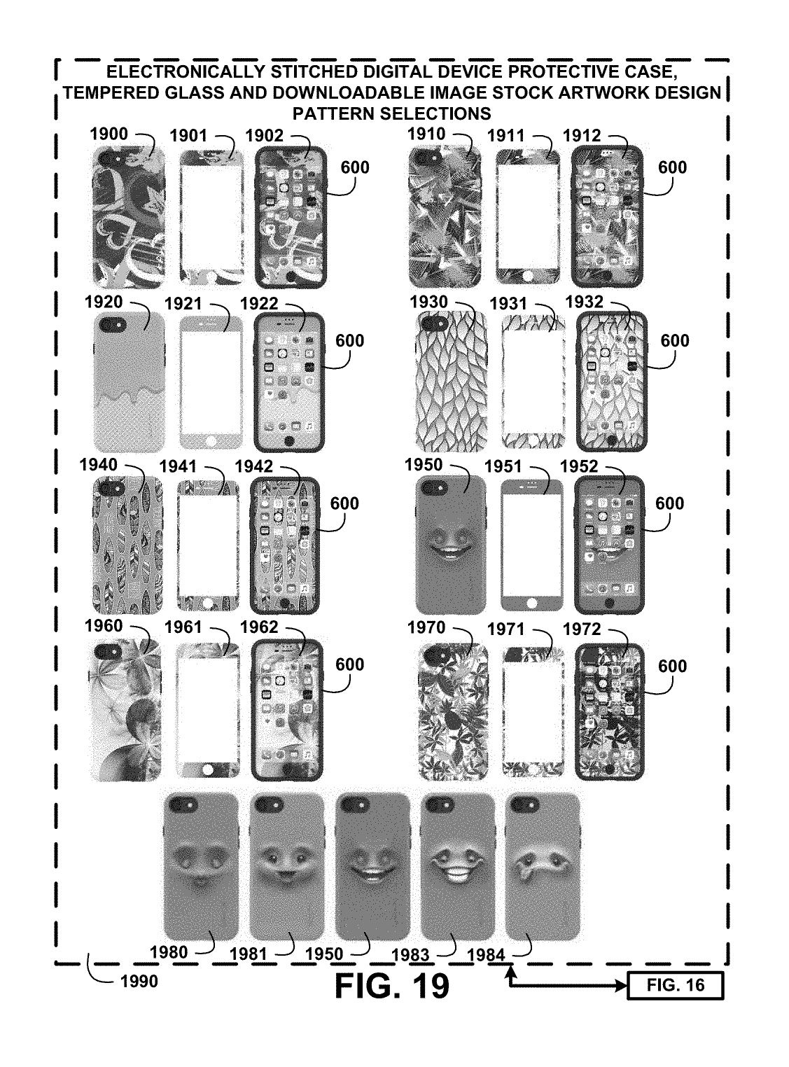

FIG. 16 shows a block diagram of an overview of a user selected stock artwork design and digital device protective case style of one embodiment. FIG. 16 shows a digital device protective case and tempered glass set with electronically stitched artwork design features website 1600. A user logs onto the website using a user digital device with internet connectivity 1610. The user places an order for a personalized digital device protective case 1620. The user enters the make and model of the user digital device 1630. The user selects a stock artwork design 1640 from those shown in FIG. 19. The user selects a digital device protective case style 1650 from those shown in FIG. 18. The website processor assigns a user personalized unique identification number to the user order 1660. The website loads the user entered make and model of the user digital device and user selected stock artwork design into website digital processors 1670. The website processor downloads factory specifications of the user digital device from a website digital device database 1680 of one embodiment. The description continues on FIG. 17.

### User Artwork Design Downloadable Image:

FIG. 17 shows a block diagram of an overview of a user artwork design downloadable image of one embodiment. FIG. 17 shows a continuation from FIG. 16 including the website processor converts the user selected stock artwork design into a digital electronically stitched seamless wraparound pattern 1700. The website processor transmits the converted user selected stock artwork design seamless wraparound pattern to image application devices 1710. The image application devices applies the electronically stitched seamless wraparound pattern onto the case flexible bumper and flexible back cover, hard outer shell and tempered glass case front face 1720. The website processor converts the user selected stock artwork design into a digital electronically stitched downloadable image for home screen and screen saver usages on the user digital device 1730. The website processor digitally processes the user payment and prints shipping instructions including shipping labels and downloading instructions for the user 1740. Downloading instructions for the user includes a user personalized artwork design unique identification number including a barcode on retail packaging, a URL link, via an email message, via a text message or the like 1750. The user order for a personalized digital device protective case is shipped 1760 of one embodiment.

### Digital Device Protective Case Styles:

FIG. 18A shows a block diagram of an overview of digital device protective case styles of several embodiments. FIG. 18A shows a continuation from FIG. 16 including several digital device protective case styles 1800 from which a user selects. The digital device protective case styles 1800 include a soft shell case bumper 1810, a flexible bumper with tempered glass covers on both sides 1811, a printed artwork front face cover film 1812, a custom print artwork glass coupled to a stock print artwork case 1813, a stock glass covers coupled to a custom print artwork case 1814, a custom glass covers coupled to a custom case 1815, a stock case coupled with a stock glass cover 1816, a stock case coupled with a clear glass cover 1817, a stock case with no glass covers 1818, a screen saver with images matching a tempered glass cover 1819, a bumper case with tempered glass back cover 1820, a bumper case with a printed artwork tempered glass back cover 1821, a tempered glass back cover coupled to a digital device coupled to a bumper 1822, a printed flexible bumper and flexible back cover 1823, and a printed artwork tempered glass back cover coupled to a digital device coupled to a bumper 1824 of several embodiments.

### Additional Digital Device Protective Case Styles:

FIG. 18B shows a block diagram of an overview of additional digital device protective case styles of several embodiments. FIG. 18B shows a continuation from FIG. 18A including additional digital device protective case styles 1800 of FIG. 18A from which a user selects. The additional digital device protective case styles include a clear tempered glass back and front covers coupled to a digital device coupled to a bumper 1825, a printed artwork tempered glass back and front covers coupled to a digital device coupled to a bumper 1826, a printed flexible bumper with a tempered glass cover coupled to a flexible back bumper 1827, a stock case with a cover insert for glass or plastic or film pattern covers 1828, a hard shell case 1829, a tempered glass front and back cover coupled to a clear soft shell case bumper 1830, a tempered glass front and back cover coupled to a clear hard shell case bumper 1831, a clear tempered glass front and back covers coupled to a digital device without a bumper 1832, an artwork design image glass front and back covers coupled to a digital device without a bumper 1833, a tempered glass front and back cover coupled to a clear hard bumper 1834, and a tempered glass front and back cover coupled to a clear soft bumper 1835 of several embodiments.

### Stock Print Case and Stock Glass Selections:

FIG. 19 shows for illustrative purposes only an example of a stock print case and stock glass selections of one embodiment. FIG. 19 shows a continuation from FIG. 16 that shows electronically stitched digital device protective case, tempered glass and downloadable image stock artwork design pattern selections 1990. The case, tempered glass and downloadable image stock artwork design pattern selections 1990 include a hard shell flower pattern 1900, a tempered glass front face flower pattern 1901, a downloadable image flower pattern 1902, a hard shell angular graphic pattern 1910, a tempered glass front face angular graphic pattern 1911, a downloadable image angular graphic pattern 1912, a hard shell ice cream cone pattern 1920, a tempered glass front face ice cream cone pattern 1921, a downloadable image ice cream cone pattern 1922, a hard shell overlapping leaf pattern 1930, a tempered glass front face overlapping leaf pattern 1931, a downloadable image overlapping leaf pattern 1932, a hard shell surfboard pattern 1940, a tempered glass front face surfboard pattern 1941, a downloadable image surfboard pattern 1942, a hard shell grinning face pattern 1950, a tempered glass front face grinning face pattern 1951, a downloadable image grinning face pattern 1952, a hard shell transparent petals pattern 1960, a tempered glass front face transparent petals pattern 1961, a downloadable image transparent petals pattern 1962, a hard shell tropical forest pattern 1970, a tempered glass front face tropical forest pattern 1971, a downloadable image tropical forest pattern 1972, a hard shell kissing face pattern 1980, a hard shell happy face pattern 1981, a hard shell grinning face pattern 1950, a hard shell smiling face pattern 1983, and a hard shell tongue out pattern 1984 of one embodiment.

Hard Outer Shell Stock Art Design Power Bank with Blinking LED Eyes:

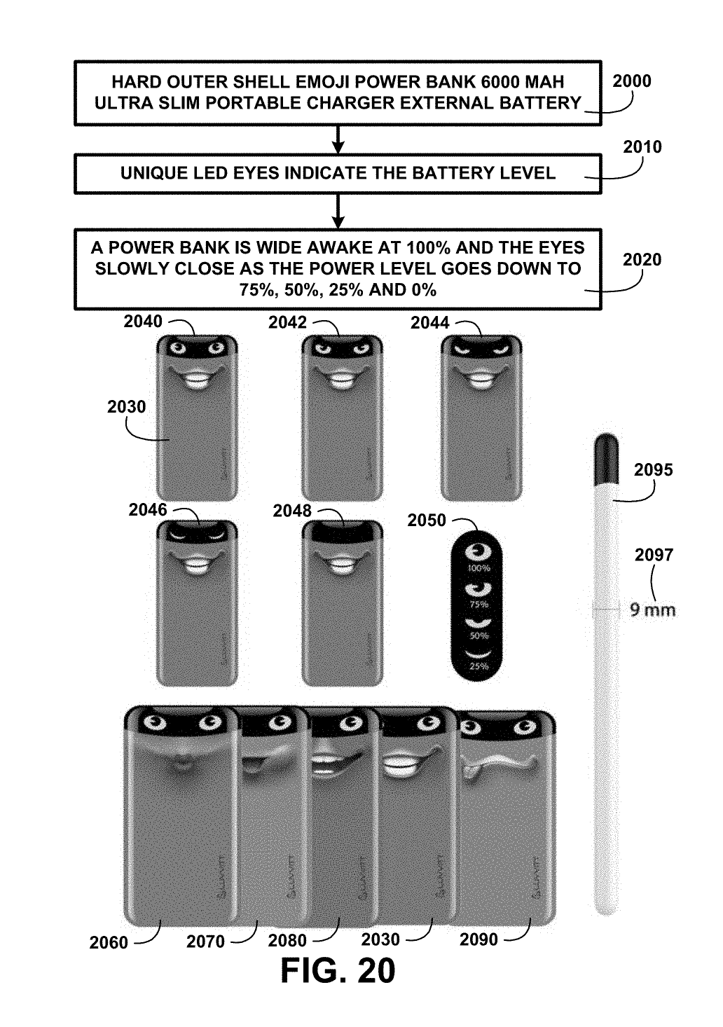

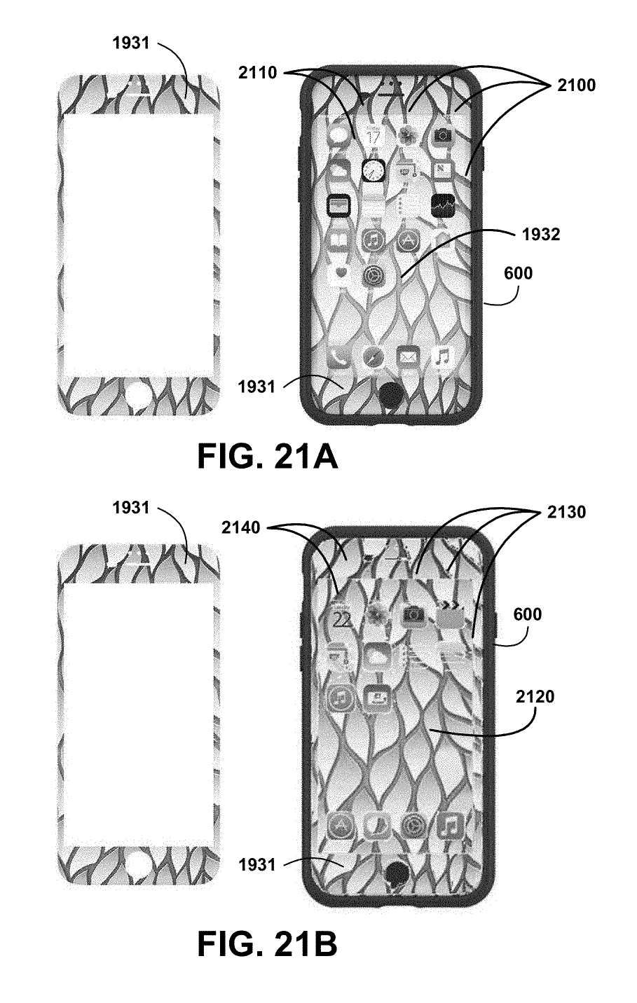

FIG. 20 shows for illustrative purposes only an example of a hard outer shell stock art design power bank with blinking LED eyes of one embodiment. FIG. 20 shows a digital device protective case hard outer shell emoji power bank 6000 mAh ultra slim portable charger external battery 2000. This hard outer shell can be attached to the digital device protective case flexible bumper 600 of FIG. 6A. The hard outer shell emoji power bank includes a unique LED eyes indicate the battery level 2010. A power bank is wide awake at 100% and the eyes slowly close as the power level goes down to 75%, 50%, 25% and 0% 2020. Illustrating the unique LED eyes battery level sequence shows a hard outer shell smiling face pattern 2030, LED eyes battery level 100% 2040, LED eyes battery level 75% 2042, LED eyes battery level 50% 2044, LED eyes battery level 25% 2046, LED eyes battery level 0% 2048. The battery level indicator is displayed on an LED eyes battery level chart 2050. Various stock artwork designs include a hard outer shell kissing face pattern 2060, a hard outer shell happy face pattern 2070, a hard outer shell grinning face pattern 2080, a hard outer shell smiling face pattern 2030, and a hard outer shell tongue out pattern 2090. A hard outer shell emoji power bank side view 2095 show a 9 mm depth dimension 2097 of one embodiment.

### Electronically Stitched Artwork Designs:

FIG. 21A shows for illustrative purposes only an example of electronically stitched artwork designs of one embodiment. FIG. 21A shows the digital device protective case tempered glass front face overlapping leaf pattern 1931 stock artwork design. The tempered glass front face overlapping leaf pattern 1931 stock artwork design is shown attached to the digital device protective case flexible bumper 600. Shown in this example is the downloadable image overlapping leaf pattern 1932 downloaded and displayed on the user digital device installed in the digital device protective case flexible bumper 600 behind the tempered glass front face overlapping leaf pattern 1931. Corresponding electronically stitched artwork design images 2110 of the tempered glass front face overlapping leaf pattern 1931 and the downloadable image overlapping leaf pattern 1932 home screen are shown. Points of the electronically stitched artwork design transitional content 2100 illustrate the seamless transitions of the overlapping leaf pattern from the tempered glass front face overlapping leaf pattern 1931 and downloadable image overlapping leaf pattern 1932 home screen. The electronically stitched artwork design transitional content 2100 is created with seamless artwork designs between each of the adjacent digital device protective case components providing the user with a fashionable digital device protective case of one embodiment.

Artwork Design Applications without Electronic Stitching:

FIG. 21B shows for illustrative purposes only an example of artwork design applications without electronic stitching of one embodiment. FIG. 21B shows the tempered glass front face overlapping leaf pattern 1931 also when it is attached to the digital device protective case flexible bumper 600. Additionally shown is a home screen artwork design application without electronic stitching 2120. Corresponding non-electronically stitched artwork design images 2140 clearly show points of non-electronically stitched artwork design misalignments 2130. The lack of the seamless transitions created using the electronic stitching produces an unappealing abrupt incongruous misaligned meeting of the artwork design images and patterns. A user looking at the poor non-seamless application of artwork designs throughout the day will soon tire of the lack of visual appeal of one embodiment.

### Personalized Middle Section Images:

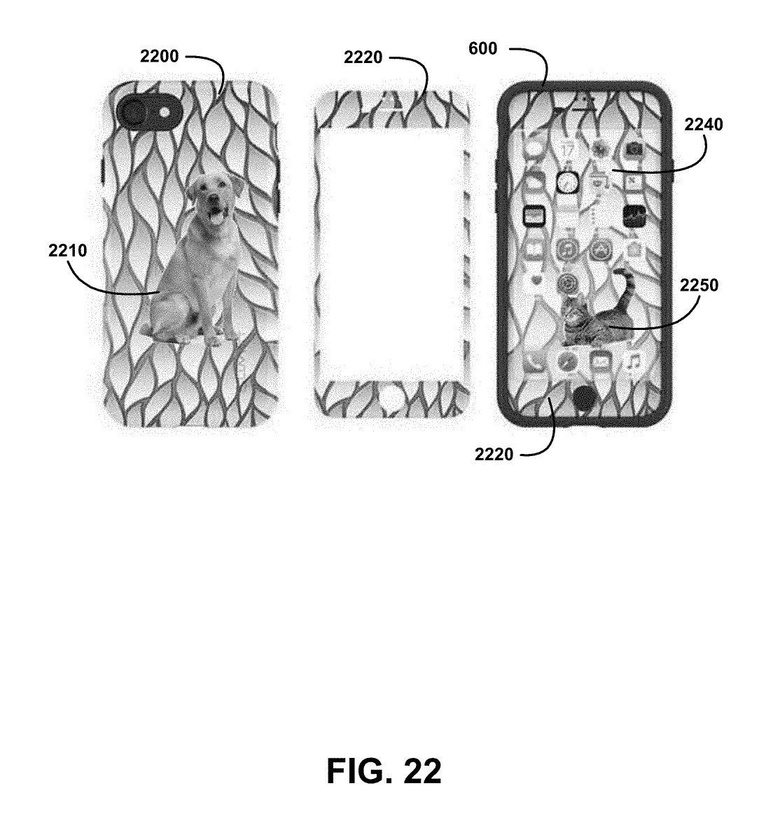

FIG. 22 shows for illustrative purposes only an example of seamless artwork design applications with personalized middle section images of one embodiment. FIG. 22 a digital device protective case back with a seamless artwork design 2200. Integrated into the seamless artwork design is for example a user's pet dog image 2210. Also showing is a tempered glass front face with the same seamless artwork design 2220. The tempered glass front face with the same seamless artwork design 2220 is installed on the bumper 600. A downloadable home screen image 2240 is displayed with for example an integrated user's pet cat image 2250. An digital device protective case back with a seamless artwork design 2200 with an integrated middle section of for example a user's pet dog image 2210 and a downloadable home screen image 2240 with an integrated middle section of for example a user's pet cat image 2250 can be installed to form one digital device protective case set of one embodiment.

Seamless Artwork Design Applications with Holographic Images:

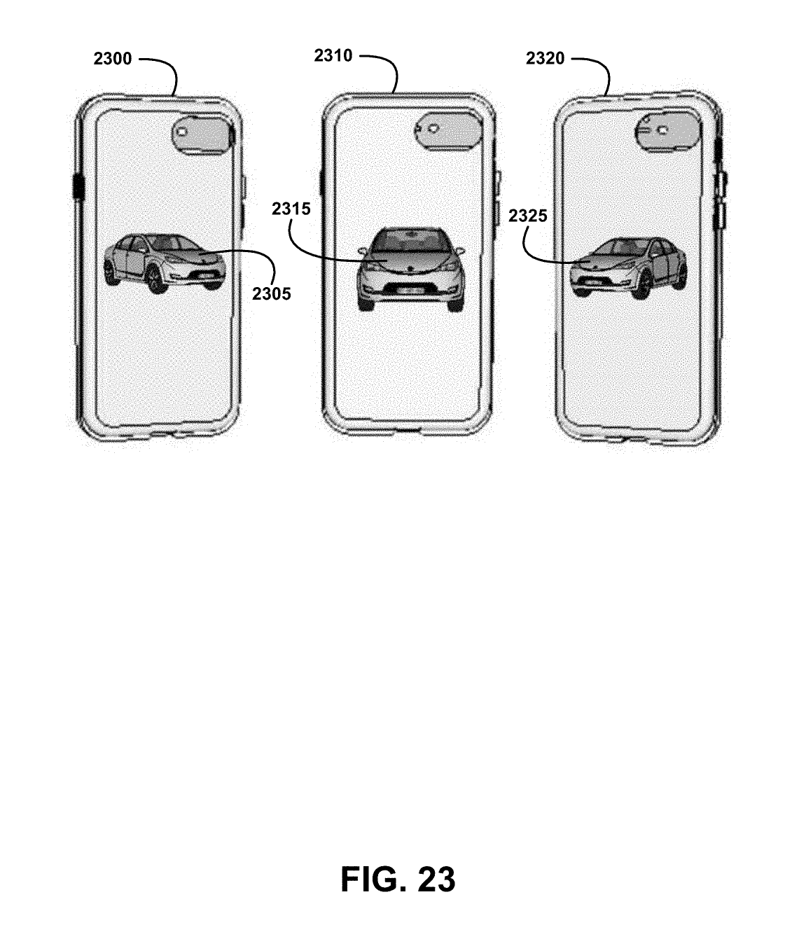

FIG. 23 shows for illustrative purposes only an example of seamless artwork design applications with holographic images of one embodiment. The seamless artwork design applications include integrated middle sections of other images and maintain the seamless electronically stitched edges. FIG. 23 shows a digital device protective case back in a right tilt view 2300 with an integrated middle section holographic artwork design pattern car in a corresponding right tilt view 2305. Showing in the middle of FIG. 23 is a digital device protective case back in a no tilt view 2310 with an integrated middle section holographic artwork design pattern car in a corresponding no tilt view 2315. On the right of FIG. 23 is a digital device protective case back in a left tilt view 2320 with an integrated middle section holographic artwork design pattern car in a corresponding left tilt view 2325 of one embodiment.

### Digital Device Protective Case Vending Machine:

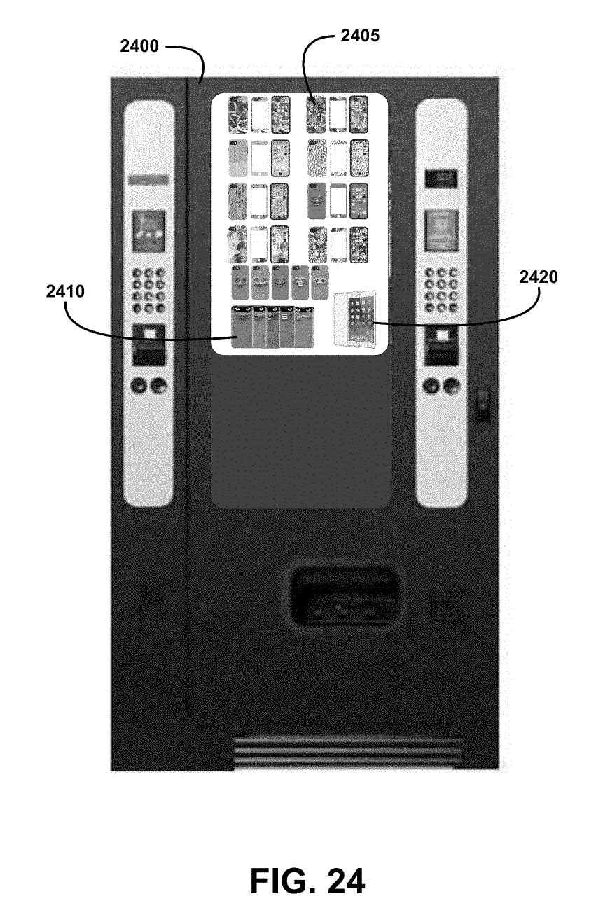

FIG. 24 shows for illustrative purposes only an example of a digital device protective case vending machine of one embodiment. FIG. 24 shows for example a digital device protective case vending machine 2400 where a user can purchase a digital device protective case. The digital device protective case vending machine 2400 includes a tough screen display with digital device protective case stock artwork designs and styles and other products. A user can touch the selection to see the price, pick from a selection of digital devices that is also displayed with the price information, insert a credit or debit bank card or cash, and their selection for the specified digital device is dispensed at the bottom of the digital device protective case vending machine 2400.

User selections include digital device protective case stock artwork design pattern selections 2405, a hard outer shell EMOJI Power Bank 6000 mAh Ultra Slim Portable Charger External Battery with unique LED eyes indicate the battery level 2410 and a tablet clear flexible rubber digital device protective case 2420.

In another embodiment the device protective artwork case vending machine 2400 is wirelessly connected to the digital device protective case website 110. The user can touch a selection of the digital device protective case style and when that image is displayed choose an option to personalize the digital device protective case artwork design. The user makes the payment for the personalized digital device protective case. The device protective artwork case vending machine 2400 includes a scanning section on the display panel on which the user may place the personalized artwork image. The image is transmitted to the digital device protective case website 110 which processes the personalized artwork image into an electronically stitched artwork design. The user personalized electronically stitched artwork design is transmitted to the device protective artwork case vending machine 2400 where the user personalized electronically stitched artwork design is applied to the user selected digital device protective case style and after a short drying process is dispensed to the user.

In another embodiment the functions of the device protective artwork case vending machine 2400 can be installed in a kiosk with a representative on duty to assist a user.

### Magnet Coupled Digital Device Protective Case:

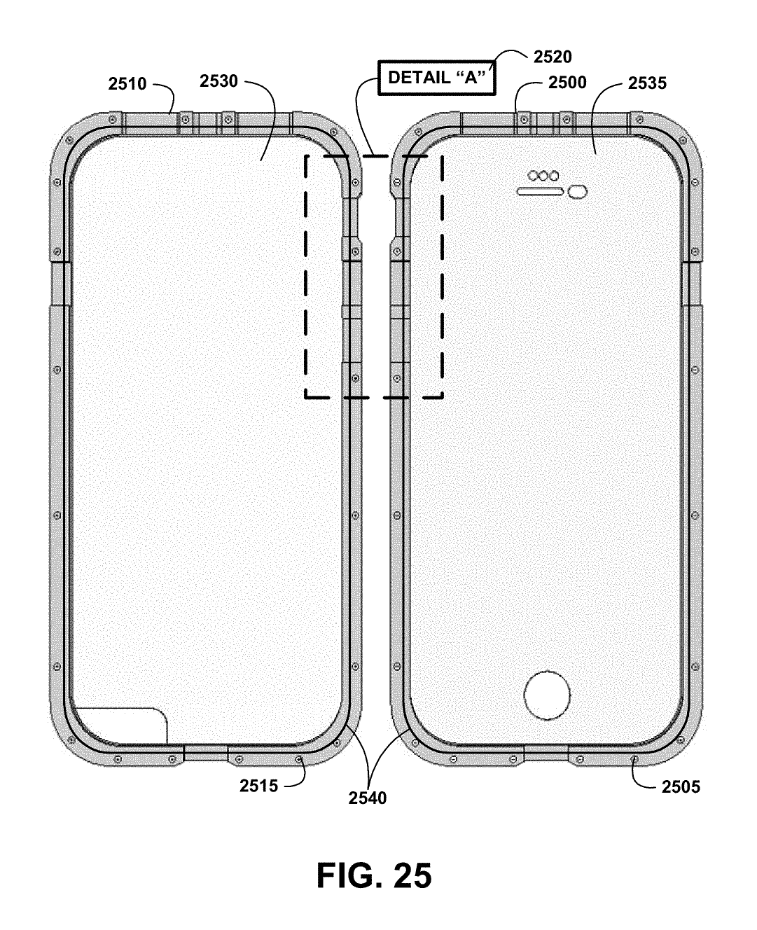

FIG. 25 shows for illustrative purposes only an example of magnet coupled digital device protective case of one embodiment. A digital device protective case includes at least one bumper section wherein a front face is coupled to one side and a back face is coupled to the other side. A digital device protective case includes at least one bumper section wherein a face is coupled to one side only. A digital device protective case includes at least one bumper section wherein no face is coupled to any side. A digital device protective case includes at least one bumper section wherein the back side is solid with a cutout for a camera. The digital device protective case including at least one bumper section made of at least one suitable protective case material including soft flexible plastic, hard plastic, a glass and a metal. The digital device protective case face including a front face and a back face is made of at least one suitable protective case cover material including tempered glass, flexible tempered glass, laminated glass and plastic. FIG. 25 shows a front magnet coupled case bumper 2500 and a back magnet coupled case bumper 2510 for forming a magnet coupled digital device protective case.

A front magnet coupled case bumper 2500 and a back magnet coupled case bumper 2510 can be made of at least one suitable protective case material including a soft flexible plastic or rubberized material including thermoplastic polyurethane (TPU), a hard setting plastic including a polycarbonate, a tempered glass, a metal including aluminum and titanium. A tempered glass front face 2535 includes cutouts to access a digital device features including buttons, home button, speaker and microphone. A tempered glass back 2530 includes a camera cutout. The tempered glass front face 2535 in one embodiment includes an artwork design. In one embodiment a tempered glass back 2530 includes an artwork design. Artwork designs include stock artwork designs and customer user submitted artwork designs. Stock artwork designs are selected from other than customer user summited designs and are bulk produced. Customer user submitted artwork designs are custom produced for the customer user devices.

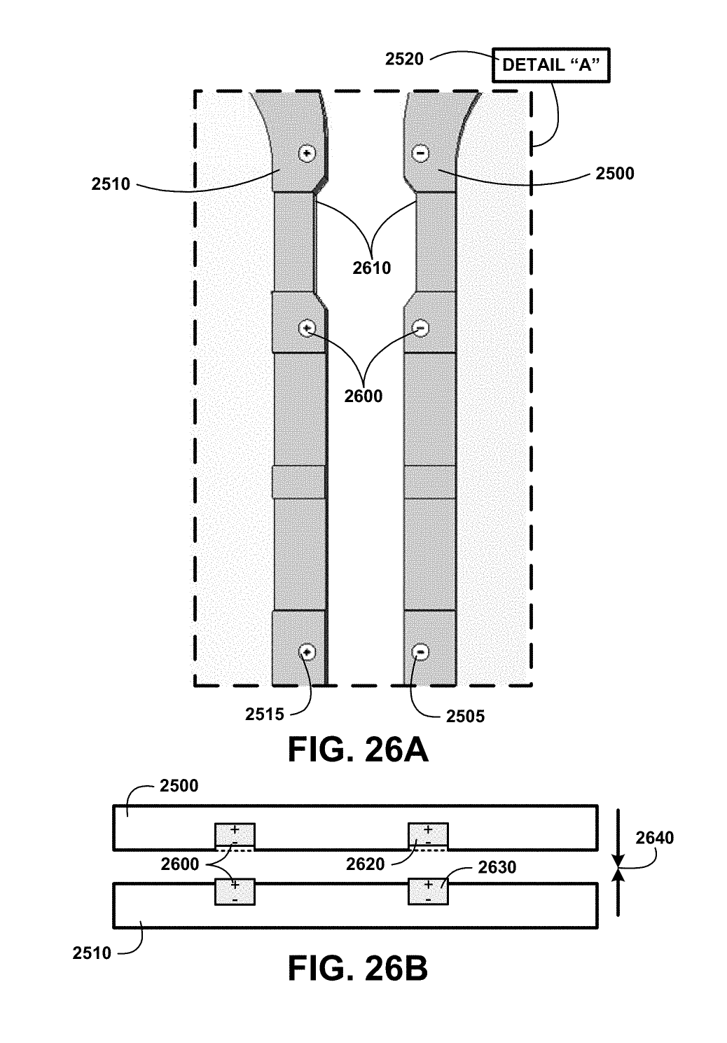

The front magnet coupled case bumper 2500 in one embodiment includes a plurality of a magnet with negative pole exposed 2505. The back magnet coupled case bumper 2510 in one embodiment includes a plurality of a magnet with positive pole exposed 2515. The plurality of a magnet with negative pole exposed 2505 and plurality of a magnet with positive pole exposed 2515 include complimentary opposing poles as shown in detail “A” 2520 as described in FIG. 26. It is generally understood that like magnetic poles positive-positive and negative-negative repulse each other, where opposite poles positive-negative attract each other. The complimentary opposing poles create an attractive force to hold the two case sections together. The magnets used in the front magnet coupled case bumper 2500 and back magnet coupled case bumper 2510 can be cylindrical or rectangular in shape. The magnets can be made of various materials including a ferromagnetic metal including iron, nickel or cobalt, ceramic and flexible materials. The magnets can be recessed into the case bumper material completely leaving a recessed receptacle and partially recessed leaving a protruding portion of the magnet to fit into the receptacle. The case bumper material includes a ferromagnetic metal for example iron, nickel or cobalt to create a redirecting shield 2540 for redirecting the lines of flux of the magnets away from the areas of the phone to prevent magnet interference with the phone functions of one embodiment.

### Complimentary Opposing Magnet Poles:

FIG. 26A shows for illustrative purposes only an example of complimentary opposing magnet poles of one embodiment. FIG. 26A shows the complimentary opposing poles detail “A” 2520. The front magnet coupled case bumper 2500 and back magnet coupled case bumper 2510 include complimentary opposing mirrored features 2610 and complimentary opposing poles 2600 position along the inner faces of the case bumpers. The front magnet coupled case bumper 2500 with a plurality of magnet with negative pole exposed 2505 components and the back magnet coupled case bumper 2510 with a plurality of magnet with positive pole exposed 2515 components wherein the exposed magnetic poles with complimenting positions create a magnetic attractive coupling force when brought in close proximity and final contact. FIG. 26 shows the tempered glass back 2530 and tempered glass front face 2535 attached to the front magnet coupled case bumper 2500 and back magnet coupled case bumper 2510 where in another embodiment tempered glass and tempered glass with artwork can be installed separately and the magnet coupled case bumpers can be frames without any glass faces installed.

### Complimentary Opposing Magnet Guides:

FIG. 26B shows for illustrative purposes only an example of complimentary opposing magnet guides of one embodiment. FIG. 26B shows the front magnet coupled case bumper 2500 and back magnet coupled case bumper 2510 with the complimentary opposing poles 2600. The front magnet coupled case bumper 2500 has a recessed magnet negative pole 2620 to create a receptacle for the back magnet coupled case bumper 2510 with a protruded magnet with positive pole 2630 to allow interior case faces meet with flush coupling 2640 to bring the front face tempered glass against a phone screen glass for a positive screen responsiveness. The recessed and protruded magnets additionally are guides to insure the proper mating of the front and back bumpers is made initially and the interior faces do not slip on a smooth surface of one embodiment.

### Magnet Coupled Digital Device Protective Case Assembly:

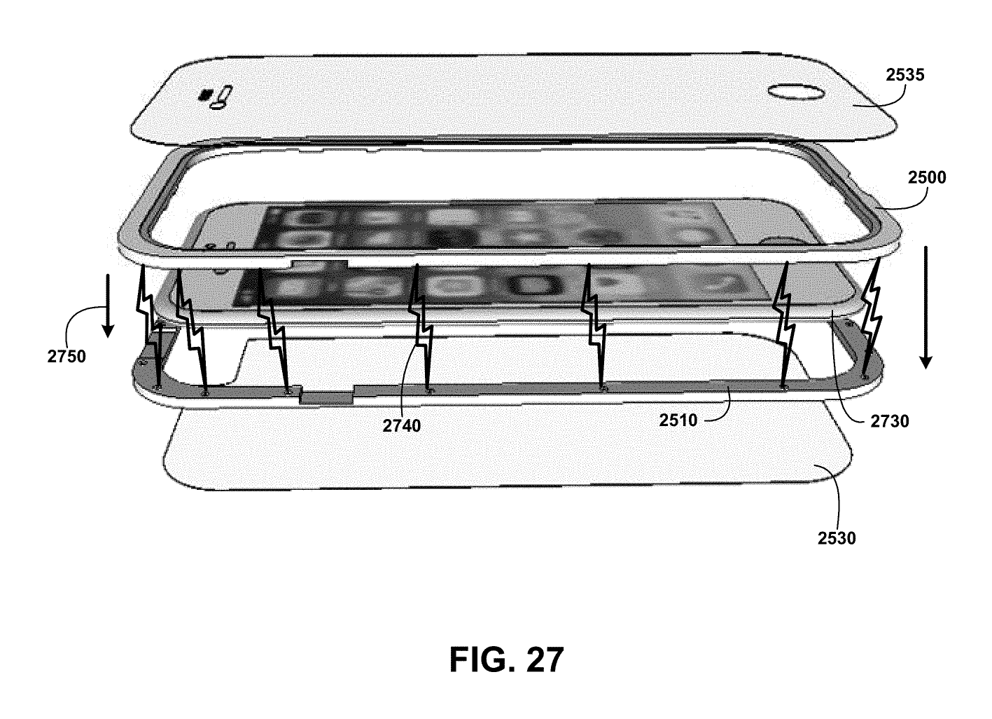

FIG. 27 shows for illustrative purposes only an example of magnet coupled digital device protective case assembly of one embodiment. FIG. 27 shows the front magnet coupled case bumper 2500 and back magnet coupled case bumper 2510 with a phone positioned between front and back magnet coupled bumpers 2730. To cause a magnetic attractive force 2740 a phone is lowered on the magnet back case bumper 2750 then a magnet front case bumper is lowered onto the magnet back case bumper 2760. The mating of the opposing magnetic poles couple the magnet front and back case bumpers together. The tempered glass front face 2535 may be pre-coupled to the front magnet coupled case bumper 2500. The tempered glass front face 2535 may be coupled to the front magnet coupled case bumper 2500 by a user before or after the coupling of the front magnet coupled case bumper 2500 to the back magnet coupled case bumper 2510. The tempered glass back 2530 may be pre-coupled to the back magnet coupled case bumper 2510. The tempered glass back 2530 may be coupled to the back magnet coupled case bumper 2510 by a user before or after the coupling of the back magnet coupled case bumper 2510 to the front magnet coupled case bumper 2500 in one embodiment.

### Slide Coupled Digital Device Protective Case:

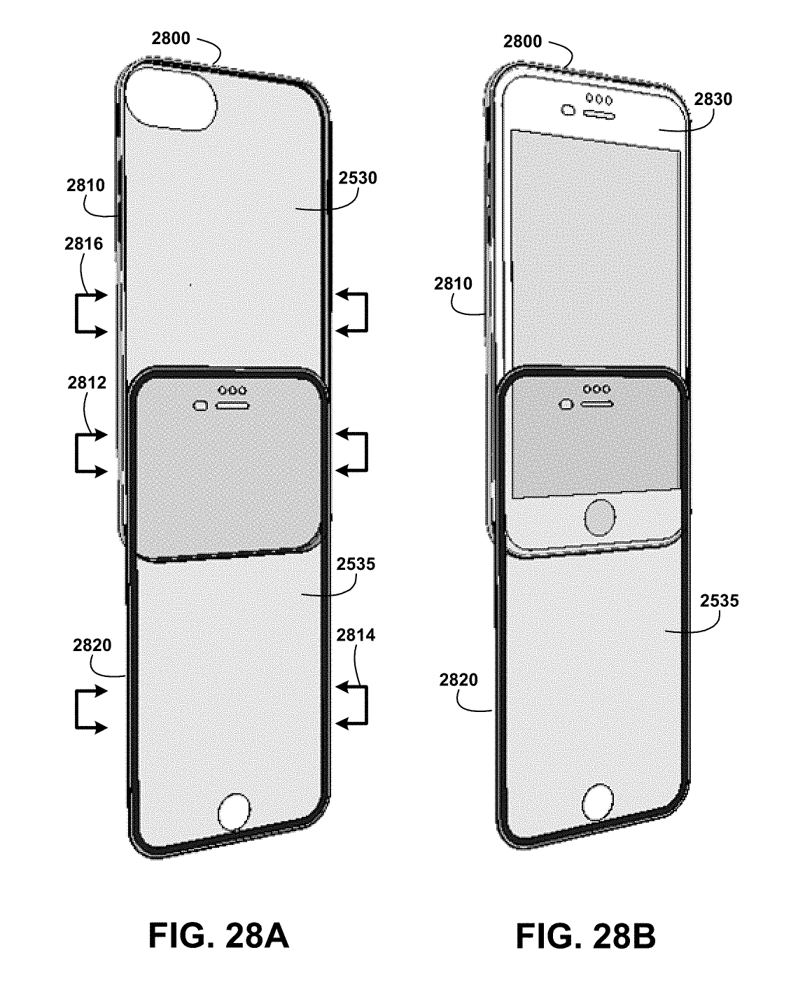

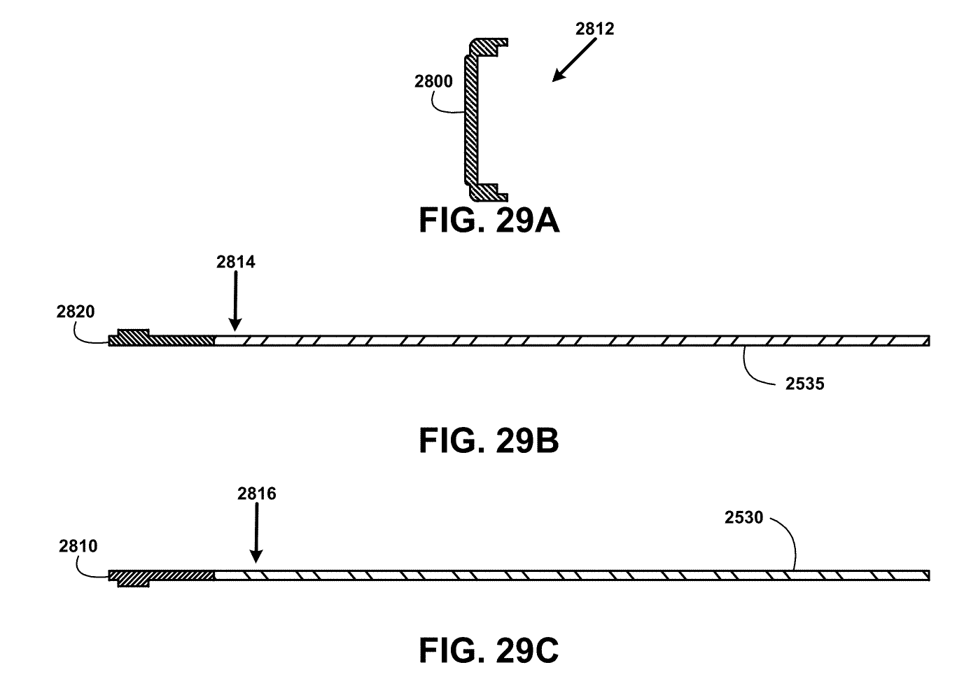

FIG. 28A shows for illustrative purposes only an example of slide coupled digital device protective case of one embodiment. FIG. 28A shows a slide coupled digital device protective case 2800 including a back slide coupling 2810 with the tempered glass back 2530 slid into position and a front slide coupling 2820 with the tempered glass front face 2535 sliding into position. A phone is slid into the slide coupled digital device protective case 2800 with the back slide coupling 2810 with the tempered glass back 2530 slid into position. The front slide coupling 2820 with the tempered glass front face 2535 can be slid through the slide coupled digital device protective case 2800 to cover the phone screen. The slide coupled digital device protective case 2800 can exert a pressure on the front slide coupling 2820 with the tempered glass front face 2535 to position the tempered glass front face 2535 against the phone screen. FIG. 28A shows a slide coupled digital device protective case 2800 cross section 2812. FIG. 28A shows a front slide coupling 2820 with the tempered glass front face 2535 cross section 2814. FIG. 28A shows a back slide coupling 2810 with the tempered glass back 2530 cross section 2816. Cross sections 2812, 2814 and 2816 are described in FIGS. 29A, 29B and 29C respectively.

Slide Coupled Digital Device Protective Case with Phone:

FIG. 28B shows for illustrative purposes only an example of slide coupled digital device protective case with phone of one embodiment. FIG. 28B shows a phone slid into the slide coupled digital device protective case 2800 with the back slide coupling 2810 with the tempered glass back 2530 slid into position. The front slide coupling 2820 with the tempered glass front face 2535 can be slid into position covering the phone screen. The front slide coupling 2820 with the tempered glass front face 2535 provides front protection of the phone and the tempered glass front face 2535 is pressed against the phone screen. The front slide coupling 2820 allows the tempered glass front face 2535 to be pressed against by the phone screen when fully slid into place of one embodiment.

### Slide Coupled Digital Device Protective Case Cross Section:

FIG. 29A shows for illustrative purposes only an example of a slide coupled digital device protective case cross section of one embodiment. FIG. 29A shows the slide coupled digital device protective case cross section 2812. The slide coupled digital device protective case 2800 is a “C” shape that can spring when sliding in the front slide coupling 2820 of FIG. 28A with the tempered glass front face 2535 of FIG. 25 and/or back slide coupling 2810 of FIG. 28A with the tempered glass back 2530 of FIG. 25 of one embodiment.

### Front Slide Coupling Cross Section:

FIG. 29B shows for illustrative purposes only an example of a front slide coupling cross section of one embodiment. FIG. 29B shows the front slide coupling cross section cross section 2814 of the front slide coupling 2820 and tempered glass front face 2535 of one embodiment.

### Back Slide Coupling Cross Section:

FIG. 29C shows for illustrative purposes only an example of a back slide coupling cross section of one embodiment. FIG. 29C shows the back slide coupling cross section cross section 2816 of the back slide coupling 2810 and tempered glass back 2530 of one embodiment.

Back Slide Coupling Slid into Position:

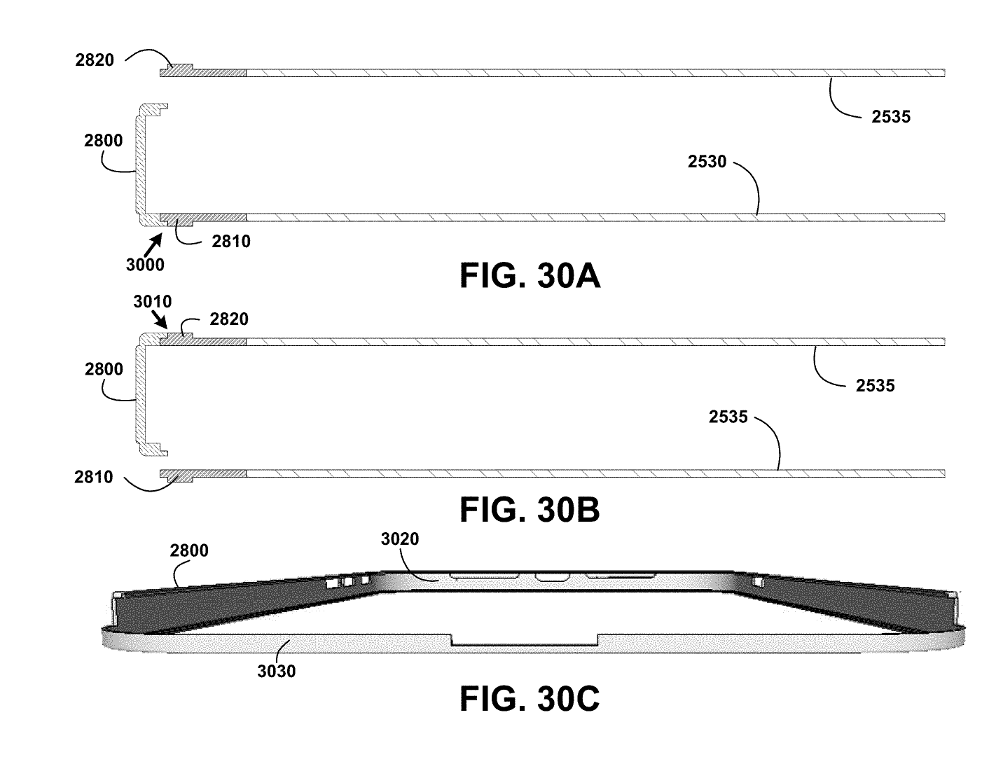

FIG. 30A shows for illustrative purposes only an example of a back slide coupling slid into position of one embodiment. FIG. 30A shows the back slide coupling 2810 with the tempered glass back 2530 slid into position 3000 with the slide coupled digital device protective case 2800. The back slide coupling 2810 with the tempered glass back 2530 slid into position 3000 provides protection to a phone install into the slide coupled digital device protective case 2800 of FIG. 28A of one embodiment.

Front Slide Coupling Slid into Position:

FIG. 30B shows for illustrative purposes only an example of a front slide coupling slid into position of one embodiment. FIG. 30B shows the front slide coupling 2820 with the tempered glass front face 2535 slid into position 3010 with the slide coupled digital device protective case 2800. A phone slid into the slide coupled digital device protective case 2800 can apply pressure on the slide coupled digital device protective case 2800 in the front and back. This pressure creates a spring force pushing the extended sections of the “C” shape. The spring force can apply a recoiling force against both the back slide coupling 2810 of FIG. 28A and the front slide coupling 2820. The recoiling force applies pressure on the tempered glass front face 2535 pushing it against a phone screen to provide contact for responsiveness of the phone touch screen functions of one embodiment.

### Slide Coupled Digital Device Protective Case Open End:

FIG. 30C shows for illustrative purposes only an example of a slide coupled digital device protective case open end of one embodiment. FIG. 30C shows a prospective view of a slide coupled digital device protective case 2800 with a continuous shape profile 3020 at one end to seat a digital device and a partially open shape forming an open end 3030 profile at the opposite end to provide a space to slide a digital device including a phone into the slide coupled digital device protective case 2800. The at least one slide coupled digital device protective case can be made of at least one suitable protective case material including a soft flexible plastic or rubberized material including thermoplastic polyurethane (TPU), a hard setting plastic including a polycarbonate, a tempered glass, a metal including aluminum and titanium of one embodiment.

### Independently Coupled Digital Device Protective Case Bumpers:

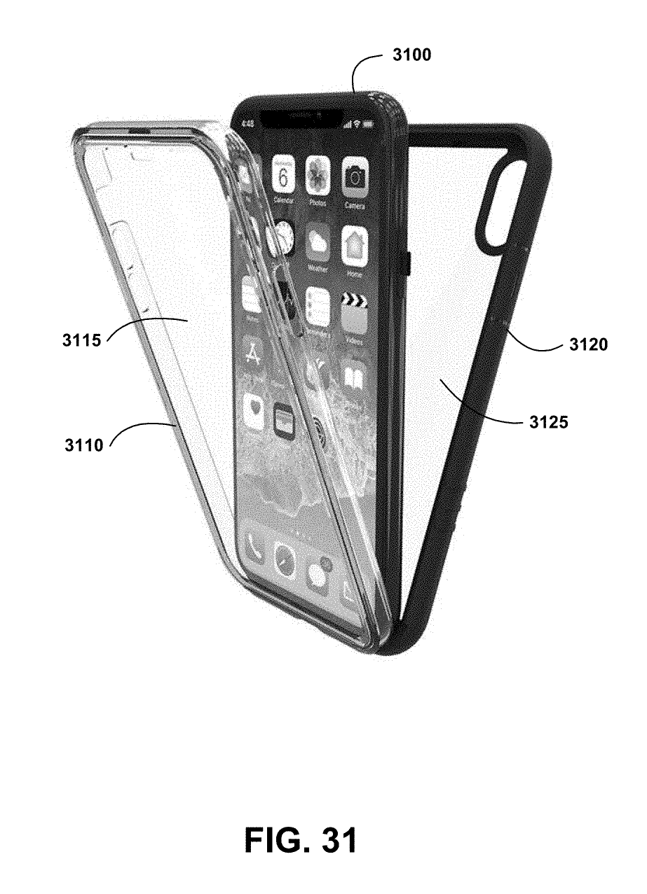

FIG. 31 shows for illustrative purposes only an example of independently coupled digital device protective case bumpers of one embodiment. FIG. 31 shows a user digital device cell phone 3100 and a digital device protective case clear front glass bumper 3110 with a clear glass front face 3115. The front glass bumper 3110 is coupled to the cell phone 3100 independent of the back bumper 3120. A digital device protective case back bumper 3120 with a clear plastic back face 3125 is shown wherein the back bumper 3120 is coupled to the cell phone 3100 independent of the front glass bumper 3110. In another embodiment the front face 3115 is a film cover. In yet another embodiment the front face 3115 is a plastic cover. The back face 3125 in one embodiment is a single layer cover. In another embodiment the back face 3125 is a double layer back cover.

### Installing a Tempered Glass Front Cover Process:

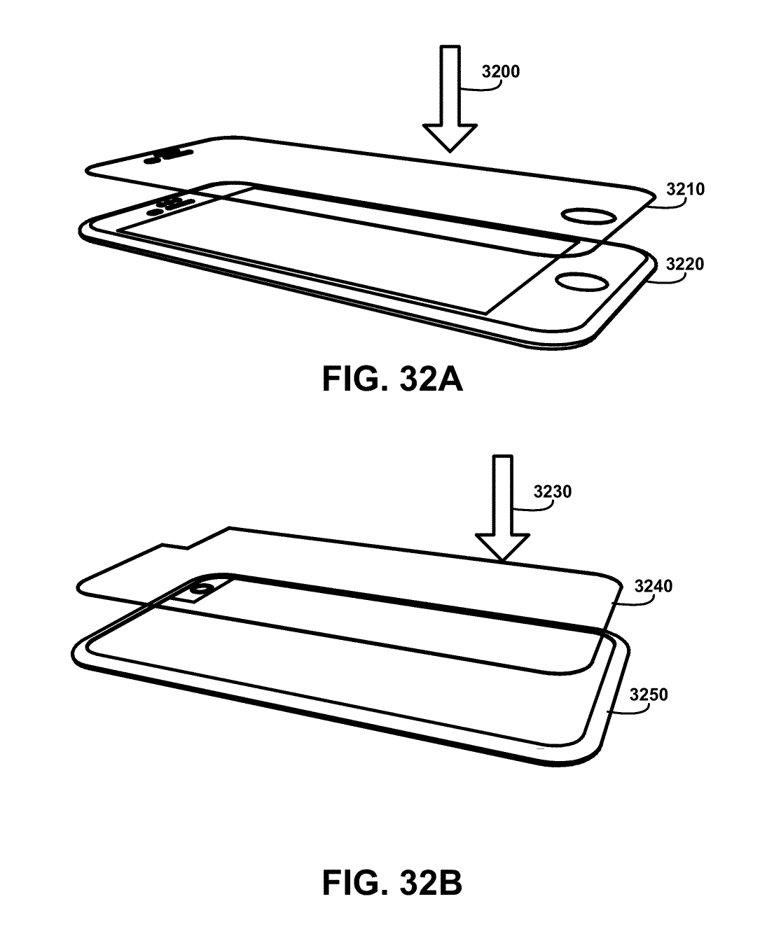

FIG. 32A shows for illustrative purposes only an example of installing a tempered glass front cover on a cell phone of one embodiment. FIG. 32A shows installing a tempered glass front cover on the surface of a cell phone 3200. The cell phone 3220 front screen has a glass surface. In one embodiment an installation process begins with wiping clean the glass surface of the cell phone 3220. A tempered glass front cover 3210 is positioned on the screen glass surface to match edges. The installation process continues with sliding with pressure applied a dry clean cloth from the center of the screen area outward to the edges to push air that may be trapped between the tempered glass front cover 3210 and the glass surface of the cell phone 3220. The tempered glass front cover 3210 will be coupled to the glass surface of the cell phone 3220 by the static friction occurring between the two glass surfaces of one embodiment.

### Installing a Tempered Glass Back Cover Process:

FIG. 32B shows for illustrative purposes only an example of installing a tempered glass back cover on a cell phone of one embodiment. FIG. 32B shows installing a tempered glass back cover on the surface of a cell phone back side 3230. The cell phone back side 3250 may have a glass surface. In one embodiment an installation process begins with wiping clean the glass surface of the cell phone back side 3250. A tempered glass back cover 3240 is positioned on the screen glass surface to match edges. The installation process continues with sliding with pressure applied a dry clean cloth from the center of the screen area outward to the edges to push air that may be trapped between the tempered glass back cover 3240 and the glass surface of the cell phone back side 3250. The tempered glass back cover 3240 will be coupled to the glass surface of the cell phone back side 3250 by the static friction occurring between the two glass surfaces of one embodiment.

The foregoing has described the principles, embodiments and modes of operation of the embodiments. However, the embodiments should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. An apparatus, comprising:
at least one digital device protective case including a magnet coupled digital device protective case;
a front magnet coupled case bumper of the magnet coupled digital device protective case including a plurality of magnets;
a back magnet coupled case bumper of the magnet coupled digital device protective case including a plurality of magnets;
a tempered glass front face for coupling to the front magnet coupled case bumper; and
a tempered glass back for coupling to the back magnet coupled case bumper.

2. The apparatus of claim 1, wherein the magnet coupled digital device protective case includes the front magnet coupled case bumper including embedding a plurality of magnets recessed into the front magnet coupled case bumper with one magnetic pole exposed.

3. The apparatus of claim 1, wherein the magnet coupled digital device protective case includes the back magnet coupled case bumper including embedding a plurality of magnets recessed into the back magnet coupled case bumper with one magnetic pole exposed opposite to a magnetic pole of the front magnet coupled case bumper.

4. The apparatus of claim 1, wherein the magnet coupled digital device protective case includes the plurality of magnets fully recessed into one magnet coupled case bumper material leaving a recessed receptacle.

5. The apparatus of claim 1, wherein the magnet coupled digital device protective case includes the plurality magnets partially recessed into an opposing magnet coupled case bumper leaving a protruding portion of each magnet to fit into a recessed receptacle.

6. The apparatus of claim 1, wherein the magnet coupled digital device protective case includes magnets made of a ferromagnetic metal including iron, nickel or cobalt, ceramic and flexible materials.

7. The apparatus of claim 1, wherein the magnet coupled digital device protective case includes embedding a redirecting shield into the front magnet coupled case bumper and the back magnet coupled case bumper for redirecting lines of flux of the plurality of magnets away from a digital device including a phone to prevent magnet interference with digital device functions.

8. The apparatus of claim 1, wherein the front magnet coupled case bumper is made of at least one suitable protective case material including a soft flexible plastic, a soft flexible rubber material, a hard setting plastic, tempered glass, a metal.

9. The apparatus of claim 1, wherein the back magnet coupled case bumper is made of at least one suitable protective case material including a soft flexible plastic, a soft flexible rubber material, a hard setting plastic, tempered glass, a metal.

10. The apparatus of claim 1, wherein the front magnet coupled case bumper and back magnet coupled case bumper includes a glue ledge for coupling a tempered glass using a glue or adhesive.

11. An apparatus, comprising:
at least one slide coupled digital device protective case to protect a digital device including a phone when the digital device is slid into the at least one slide coupled digital device protective case;
a front slide coupling for sliding into the at least one slide coupled digital device protective case;
a tempered glass front face to couple to the front slide coupling;
a back slide coupling for sliding into the at least one slide coupled digital device protective case; and
a tempered glass back to couple to the back slide coupling.

12. The apparatus of claim 11, wherein the at least one slide coupled digital device protective case is “C” shaped.

13. The apparatus of claim 11, wherein the at least one slide coupled digital device protective case includes a continuous shape profile at one end to seat a digital device and a partially open shape profile at the opposite end for sliding a digital device into the at least one slide coupled digital device protective case.

14. The apparatus of claim 11, wherein the at least one slide coupled digital device protective case is a “C” shape to provide a spring force pushing extended sections of the “C” shape wherein the spring force applies a recoiling force against both the back slide coupling and the front slide coupling wherein the recoiling force applies pressure on the tempered glass front pushing it against a phone screen to provide contact for responsiveness of phone touch screen functions.

15. The apparatus of claim 11, wherein the at least one slide coupled digital device protective case includes no tempered glass.

16. An apparatus, comprising:
at least one digital device protective case including at least one bumper section to protect a digital device including a cell phone;
wherein the at least one digital device protective case includes at least one face including a front face coupled to a front side and a back face coupled to a back side;
wherein the at least one digital device protective case includes at least one bumper section wherein a face is coupled to only one side;
wherein the at least one digital device protective case includes at least one bumper section wherein no face is coupled to any side; and
wherein the at least one digital device protective case includes at least one bumper section wherein the back side is solid with a cutout for a camera.

17. The apparatus of claim 16, wherein the at least one digital device protective case including at least one bumper section made of at least one suitable protective case material including soft flexible plastic, hard plastic, a glass and a metal.

18. The apparatus of claim 16, wherein the digital device protective case face including a front face and a back face is made of at least one suitable protective case cover material including tempered glass, flexible tempered glass, laminated glass and plastic.

19. The apparatus of claim 16, wherein the at least one digital device protective case includes a magnet coupled digital device protective case including a front magnet coupled case bumper with a plurality of magnets and a back magnet coupled case bumper with a plurality of magnets wherein the plurality of magnets includes magnets made of a ferromagnetic metal including iron, nickel or cobalt, ceramic and flexible materials, in a cylindrical or rectangular shape.

20. The apparatus of claim 16, wherein the at least one digital device protective case includes at least one slide coupled digital device protective case to protect a digital device including a phone when the digital device is slid into the at least one slide coupled digital device protective case, a front slide coupling for sliding into the at least one slide coupled digital device protective case, a tempered glass front face to couple to the front slide coupling, a back slide coupling for sliding into the at least one slide coupled digital device protective case, and a tempered glass back to couple to the back slide coupling.
